(19) United States
(12) Patent Application Publication
(10) Pub. No.: US 2026/0148404 A1
(43) Pub. Date: May 28, 2026

(54) SYNTHETIC DATA GENERATION FOR TRAINING STEREO MODELS

(71) Applicant: NVIDIA Corporation, Santa Clara, CA (US)

(72) Inventors: Matthew Trepte, San Francisco, CA (US); Bowen Wen, Issaquah, WA (US); Jack Zhang, San Jose, CA (US); Gordon Grigor, San Francisco, CA (US); Stanley Thomas Birchfield, Sammamish, WA (US)

(21) Appl. No.: 19/055,036

(22) Filed: Feb. 17, 2025

Related U.S. Application Data
(60) Provisional application No. 63/723,727, filed on Nov. 22, 2024.
(60) Provisional application No. 63/726,916, filed on Dec. 2, 2024.

(51) Int. Cl. G06T 7/593; G06T 7/66; G06T 7/73; H04N 13/00; H04N 13/128; H04N 13/194; H04N 13/271

(52) U.S. Cl. CPC G06T 7/593; G06T 7/66; G06T 7/74; H04N 13/128; H04N 13/194; H04N 13/271; G06T 2207/10012; G06T 2207/20081; G06T 2207/20084; G06T 2207/20228; H04N 2013/0081

(57) ABSTRACT

Systems and methods are disclosed that curate synthetic datasets using a stereo model. For example, embodiments of the present disclosure may include an iterative process that generates a first synthetic dataset using a replicator composer, uses the generated dataset to train a stereo model such as a Foundational Stereo model, and curates a second synthetic dataset using the trained stereo model. Additionally, and/or alternatively, the synthetic datasets that were generated by the replicator composer may include multiple categories of realism such as realistic style synthetic data and chaotic style synthetic data as well as multiple categories of use cases such as navigation, driving, and manipulation. Additionally, and/or alternatively, the replicator composer may generate a scene based on determining a center of mass of objects that are generated for the scene and using the center of mass to orient the camera.

### CLAIM OF PRIORITY

This application claims the benefit of U.S. Provisional Application No. 63/726,916 (Attorney Docket No. 515199) titled “Synthetic Data Generation For Training Stereo Foundation Models,” filed Dec. 2, 2024 and U.S. Provisional Application No. 63/723,727 (Attorney Docket No. 515186) titled “Foundation Model For Zero-Shot Stereo Matching,” filed Nov. 22, 2024, the entire contents of which are incorporated herein by reference.

### BACKGROUND

Training data is essential for deep learning models, including stereo models. While cross-domain generalization has been explored previously for stereo models, such conventional approaches have not achieved results that are competitive with those obtained by fine-tuning on the target domain, either due to insufficient structure in the network architecture, impoverished training data, or both. For instance, regarding the impoverished training data, conventional stereo models are generally experimented on using a rather small dataset with only 40,000 annotated training image pairs. As a result, given the small amount of training data available, none of these conventional networks may be used as an off-the-shelf solution, which is different from the strong generalizability of vision foundation models that have emerged in other tasks. For instance, existing datasets may provide hundreds of training pairs on certain scenarios such as driving scenarios. Nevertheless, the sparse ground-truth disparity obtained by light detection and ranging (LiDAR) sensors hinders learning accurate and dense stereo matching for these training pairs. In addition, other existing datasets have developed a low number of training data that cover both indoor and outdoor scenarios beyond driving. Yet another existing dataset presents a real-world dataset focusing on transparent objects. However, challenges of scarce data size, imperfect ground-truth disparity, and lack of collection scalability in real-world scenarios have driven the widespread adoption of synthetic data for training. But, generating synthetic datasets for training stereo models may continue to remain a challenge and therefore, there may be a need for addressing these issues and/or other issues associated with generating synthetic datasets for stereo models.

### SUMMARY

Embodiments of the present disclosure relate to systems and methods for generating synthetic data for training stereo foundation models. For instance, a training dataset may be required to include sufficient data such as images to be able to adequately train a model (e.g., a network). As such, methods and processes have been described previously to generate synthetic datasets that are used for training a model. For instance, synthetic images may be generated that are then used to train models. However, because the training of foundation stereo algorithms and models as well as multi-domain generalization may require pairs of stereo images that are obtained of a scene that are displaced by a distance, conventional methods and processes that are used to generate conventional synthetic images are inadequate. For instance, in order to sufficiently train stereo models, especially a zero-shot stereo model such as a Foundational Stereo Model, the training dataset may need to comprise synthetic images in a plurality of different layouts, configurations, and/or scenarios. Without an adequate training dataset, the stereo models may be unable to perform sufficiently during inference.

To address these limitations, embodiments of the present disclosure describe a process and system for generating synthetic data for training of stereo models such as the Foundational Stereo Model. The synthetic dataset generated by embodiments of the present disclosure may account for crucial stereo matching challenges such as reflections, low-texture surfaces, and severe occlusions. Furthermore, embodiments of the present disclosure may perform domain randomization to augment dataset diversity within the synthetic dataset, including randomizing parameters such as stereo baseline, focal length, camera perspectives, lighting conditions, object configurations, and/or other parameters. In addition, embodiments of the present disclosure may generate synthetic datasets with enhanced realism in rendering and layouts based on utilizing path-tracing rendering and high-quality 3D assets with abundant textures.

While synthetic data generation may, in theory, produce unlimited amounts of data and achieve large diversity through randomization, ambiguities may be inevitably introduced. This may be especially true for less structured scenes with flying objects, which may confuse the learning process. To eliminate such samples, embodiments of the present disclosure may be configured to perform an iterative self-curation process. For instance, according to at least one embodiment, a method is provided that begins with training an initial version of a stereo model such as the Foundational Stereo Model. Following, the trained stereo model may then be used to curate a newly generated synthetic dataset. This method may repeat iteratively to further train stereo models (e.g., new stereo models and/or further train a previously trained stereo model) and use the trained stereo models to curate newly generated synthetic datasets.

In an embodiment, a computer-implemented method for curating synthetic datasets using a stereo model is provided. The method comprises generating a first synthetic dataset comprising a plurality of first stereo images based on using a replicator composer and training the stereo model based on the first synthetic dataset. The method further comprises generating a second synthetic dataset comprising a plurality of second stereo images based on using the replicator composer and curating the second synthetic dataset using the trained stereo model to remove a subset of the plurality of second stereo images from the second synthetic dataset.

### BRIEF DESCRIPTION OF THE DRAWINGS

The present systems and methods for synthetic data generation for training stereo models are described in detail below with reference to the attached drawing figures, wherein:

FIG. 1A illustrates representations of using the Foundational Stereo Model, in accordance with an embodiment.

FIG. 1B illustrates an overview of the Foundational Stereo Model, in accordance with an embodiment.

FIG. 1C below shows an overview of an example STA that includes a monocular depth estimation model, a side-tuning CNN, and a concatenation block, in accordance with an embodiment.

FIG. 2A shows an overview of using the AHCF to generate a filtered hybrid cost volume, in accordance with an embodiment.

FIG. 2B shows an overview of using the refinement block to generate the output disparity map, in accordance with an embodiment.

FIG. 3 provides a flow diagram illustrating a method for using a Foundational Stereo Model to generate an output disparity map, in accordance with an embodiment.

FIG. 4 is a conceptual diagram of a processing system implemented using a PPU, suitable for use in implementing some embodiments of the present disclosure.

FIG. 5A illustrates an exemplary system in which the various architecture and/or functionality of the various previous embodiments may be implemented.

FIG. 5B illustrates components of an exemplary system that can be used to train and utilize machine learning, in at least one embodiment.

FIG. 6 illustrates an exemplary streaming system suitable for use in implementing some embodiments of the present disclosure.

FIG. 7 shows exemplary synthetic images that are generated using embodiments of the present disclosure.

FIG. 8A shows an overview of a synthetic generation process to generate a training dataset comprising the synthetic images, in accordance with an embodiment.

FIG. 8B shows an exemplary inheritance tree that includes parameter sets for each data category that are inherited from parent parameter sets, in accordance with an embodiment.

FIG. 8C shows an overview for using a replicator composer to generate the synthetic dataset, in accordance with an embodiment.

FIG. 9 shows a process for self-pruning or curating a synthetic dataset using a stereo model, in accordance with an embodiment.

FIG. 10 provides a flow diagram illustrating a method for curating synthetic datasets using a stereo model, in accordance with an embodiment.

### DETAILED DESCRIPTION

Systems and methods are disclosed herein that relate to a foundation model for zero-shot stereo matching, and in particular, to using a Foundational Stereo Model to generate an output disparity map. For instance, stereo matching algorithms have improved significantly since their introduction nearly half a century ago. Recent stereo algorithms can achieve amazing results, almost saturating the most challenging benchmarks-thanks to the proliferation of training datasets and advances in deep neural network architectures. Yet, fine-tuning on the dataset of the target domain is still the method of choice to obtain competitive results. Given the zero-shot generalization ability shown on other problems within computer vision via the scaling law, a question arises as to what prevents stereo matching algorithms from achieving a similar level of generalization.

Leading conventional stereo networks construct cost volumes from the unary features and leverage three-dimensional (3D) CNNs for cost filtering. Refinement-based methods iteratively refine the disparity map based on recurrent modules such as GRUs. Despite their success on public benchmarks under per-domain fine-tuning setup, however, they struggle to gather non-local information to effectively scale to larger datasets. Other methods explore transformer architectures for unary feature extraction, while lacking the specialized structure afforded by cost volumes and iterative refinement to achieve high accuracy.

Such limitations have, to date, hindered the development of a stereo network that generalizes well to other domains. While it is true that cross-domain generalization has been explored by some conventional approaches, such approaches have not achieved results that are competitive with those obtained by fine-tuning on the target domain, either due to insufficient structure in the network architecture, impoverished training data, or both. These networks are generally experimented on a rather small dataset with only 40,000 annotated training image pairs. As a result, none of these methods may be used as an off-the-shelf solution, as opposed to the strong generalizability of vision foundation models that have emerged in other tasks.

To address these limitations, embodiments of the present disclosure describe a Foundational Stereo Model, which is a large foundation model for stereo depth estimation that achieves strong zero-shot generalization without per-domain fine-tuning. Embodiments of the present disclosure may train the network on a large-scale high-fidelity synthetic training dataset with high diversity and photorealism. An automatic self-curation pipeline may be developed to eliminate the ambiguous samples that are inevitably introduced during the domain randomized data generation process, improving both the dataset quality and model robustness over iterate updates. To mitigate the sim-to-real gap, embodiments of the present disclosure include a side-tuning feature backbone that adapts internet-scale rich priors from a model that is trained on real monocular images to the stereo setup. To effectively leverage these rich monocular priors embedded into the 4D cost volume, embodiments of the present disclosure further include an Attentive Hybrid Cost Volume (AHCF) module, consisting of 3D Axial-Planar Convolution (APC) filtering and a Disparity Transformer (DT). The APC filtering may decouple the standard 3D convolution into two separate spatial-oriented and disparity-oriented 3D convolutions, enhancing the receptive fields for volume feature aggregation. The DT may perform self-attention over the entire disparity space within the cost volume, providing long range context for global reasoning. Together, these may significantly enhance the representation, leading to better disparity initialization, as well as more powerful features for the subsequent iterative refinement process.

As will be described in further detail below, embodiments of the present disclosure describe a Foundational Stereo Model, which is a zero-shot generalizable stereo matching model that achieves comparable or even more favorable results to conventional models fine-tuned on a target domain. The Foundational Stereo Model may also significantly outperform conventional methods and models when applied to in-the-wild data. Embodiments of the present disclosure further create a large-scale high-fidelity synthetic dataset for stereo learning with high diversity and photorealism and a self-curation pipeline to ensure that bad samples are pruned. To harness internet-scale knowledge containing rich semantic and geometric priors, the Foundational Stereo Model includes an STA that adapts the video transformer-based monocular depth estimation model to the stereo setup. The Foundational Stereo Model may further include an AHCF, which includes an hourglass module with 3D APC and a DT module that performs full self-attention over the disparity dimension.

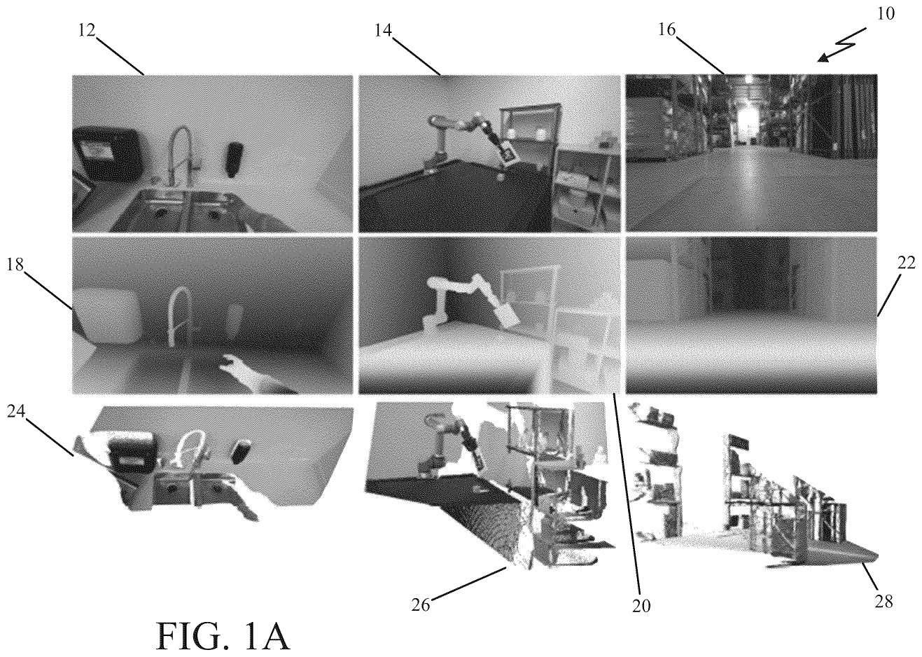

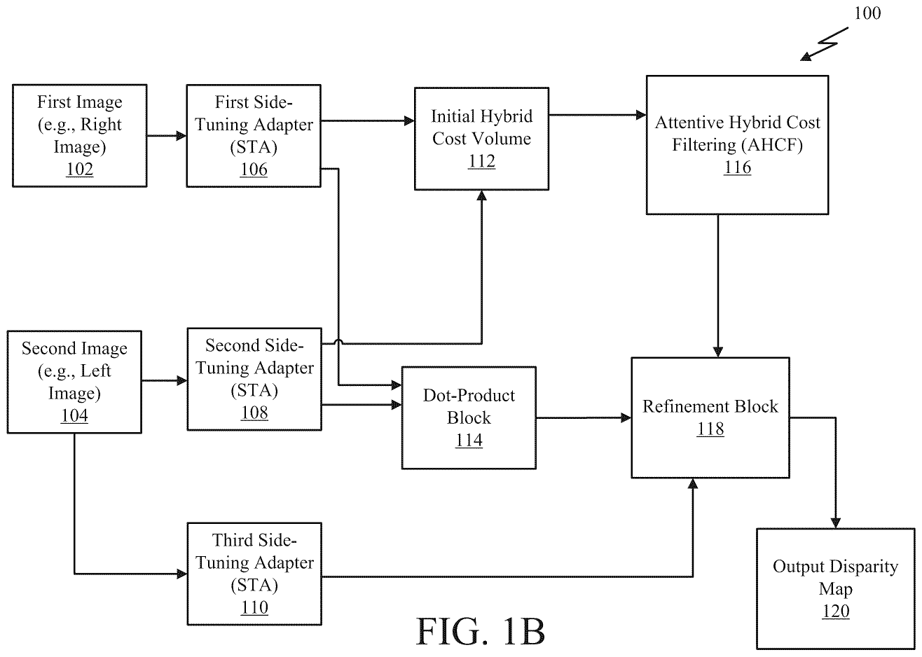

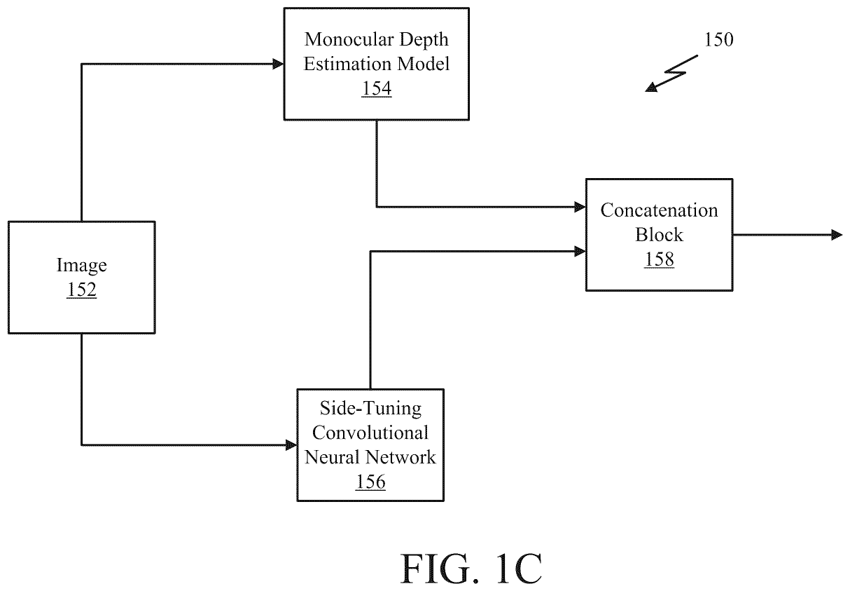

Prior to describing the Foundational Stereo Model in more detail, images, disparity maps, and point clouds are first shown and described. For example, FIG. 1A illustrates representations of using the Foundational Stereo Model, in accordance with an embodiment. For example, FIG. 1A shows three red, green, blue (RGB) images 12-16 (e.g., left RGB images). Following, the RGB images 12-16 may be processed by the Foundational Stereo Model to generate three disparity maps 18-22. Then, the three disparity maps 18-22 may be used to generate the metric point clouds 24-28.

FIG. 1B illustrates an overview 100 of the Foundational Stereo Model, in accordance with an embodiment. Each block of the overview 100, described herein, may comprise a computing process that may be performed using any combination of hardware, firmware, and/or software. For instance, various functions may be carried out by a processor executing instructions stored in memory. The overview 100 may also be embodied as computer-usable instructions stored on computer storage media. The overview 100 may be provided by a standalone application, a service or hosted service (standalone or in combination with another hosted service), or a plug-in to another product, to name a few. In addition, the overview 100 is described, by way of example, with respect to a computing system and/or platform. However, this overview 100 may additionally or alternatively be executed by any one system, or any combination of systems, including, but not limited to, those described herein. Furthermore, persons of ordinary skill in the art will understand that any system that performs the overview 100 is within the scope and spirit of embodiments of the present disclosure.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

In addition, one or more computing systems or computing platforms may be used to perform one or more blocks of the overview 100. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location.

In some embodiments, the Foundational Stereo Model may include three major aspects—the STAs (e.g., the first STA 106, the second STA 108, and the third STA 110), the AHCF 116, and the refinement block 118 that uses ConvGRUs. In particular, based on obtaining a first image 102 (e.g., a right stereo image of a scene) and a second image 104 (e.g., a left stereo image of the scene), the Foundational Stereo Model, which may include the first and second STAs 106 and 108, the AHCF 116, and the refinement block 118, may generate an output disparity map 120 (e.g., the disparity maps 18-22 shown in FIG. 1A).

For example, a first image 102 (e.g., right stereo image) and a second image 104 (e.g., left stereo image) may be obtained. The second image 104 may be the images 12-16 shown in FIG. 1A and the first image 102 may be another image of the same scene, but may be obtained by an image capturing device (e.g., a camera) that is displaced from the image capturing device that obtains the second image 104. The first and second images 102-104 may be processed by the first and second STAs 106-108, which are shown in FIG. 1C, to generate feature maps for the first image 102 and the second image 104.

For instance, the Foundational Stereo Model may include three STAs 106, 108, and 110. The first and second STAs 106 and 108 may be used to generate feature maps for the first image 102 and the second image 104. The third STA 110 may be and/or include a context network and used to generate context features associated with the second image 104. The context features may be used by the refinement block 118. The first and second STAs 106 and 108 are described in further detail in FIG. 1C. The third STA 110 is described in afterwards when describing the inputs to the refinement block 118.

FIG. 1C below shows an overview 150 of an example STA that includes a monocular depth estimation model 154, a side-tuning CNN 156, and a concatenation block 158, in accordance with an embodiment. For example, the image 152 may be the right image 102 or the left image 104 from FIG. 1B. The STA of FIG. 1C (e.g., the first or second STAs 106 and 108 of FIG. 1B) may include two models 154 and 156 that may each process the image 152. For instance, the monocular depth estimation model 154 may process the image 152 to generate monocular depth features. Further, the side-tuning CNN 156, which may be a pyramid CNN, may also process the image 152 to generate CNN pyramid features. The concatenation block 158 may concatenate the CNN pyramid features and the monocular depth features to generate a feature map, which is output from the STA.

In other words, the STA may utilize a vision transformer (ViT) and a CNN network to generate feature maps from the images. For instance, the ViT (e.g., the monocular depth estimation model 154) may be trained on internet-scale real data and while the ViT may operate adequately on typical images, the ViT may have difficulty on stereo images. As such, the CNN network (e.g., the side-tuning CNN 156) is used to adapt the VIT-based monocular depth estimation network (e.g., the monocular depth estimation model 154) for the stereo setup, which thus synergizes the strengths of both CNN and ViT architectures.

The monocular depth estimation model 154 may be any monocular depth estimation model such as, but not limited to, a DepthAnythingV2 model, which is described in Yang et al. “Depth anything v2.” In Proceedings of Neural Information processing Systems (NeurIPS), 2024 and is incorporated by reference herein. The monocular depth estimation model 154 may generate monocular depth features indicating monocular depth estimations (e.g., estimating a depth value of a pixel) of a single monocular RGB image (e.g., the image 152).

The side-tuning CNN 156 may be any type of pyramid CNN such as, but not limited to, the EdgeNeXt-S model, which is described in Maaz et al. “EdgeNeXt: Efficiently amalgamated cnn-transformer architecture for mobile vision applications.” In Proceedings of the European Conference on Computer Vision (ECCV), pages 3-20, 2022 and is incorporated by reference herein. The side-tuning CNN 156 may generate CNN pyramid features. For example, the side-tuning CNN 156 may apply a 4×4 convolution with a stride of 4 to downscale the features from the image 152.

As such, the CNN pyramid features may indicate a height (H) and width (W) associated with the image 152 (e.g., a height and width that is divided by four given the 4×4 convolution with the stride of 4), and may further indicate the channels (C) (e.g., the features). Following, in embodiments using the DepthAnything V2 model and due to the dimensions of the CNN pyramid features, a downsampling block may be included within or separate from the monocular depth estimation model 154 that downsamples the monocular depth features to achieve similar dimensions to the CNN pyramid features. Then, the concatenation block 158 concatenates the monocular depth features and the CNN pyramid features to generate a feature map for the image 152.

In other words, to mitigate the simulation-to-real gap when the stereo network is primarily trained on synthetic dataset, the Foundational Stereo Model may use an STA that leverages the recent advancements on monocular depth estimation trained on internet-scale real data. For instance, embodiments of the present disclosure may use a CNN network (e.g., the side-tuning CNN 156) to adapt the ViT-based monocular depth estimation network (e.g., the monocular depth estimation model 154) to the stereo setup, thus synergizing the strengths of both CNN and ViT architectures.

In some embodiments, the STA may use the feature pyramids from a frozen DepthAnythingV2 model without using the CNN features. Additionally, and/or alternatively, the STA may use a ViT-adapter such as the ViT-adapted described in Chen et al. “Vision transformer adapter for dense predictions.” In ICLR, 2023 and is incorporated by reference herein.

Additionally, and/or alternatively, the STA may use the monocular depth estimation model 154 (e.g., the DepthAnythingV2 model) and the side-tuning CNN 156 (e.g., the EdgeNeXt-S model) that is described above. For instance, given a pair of left and right images Iₗ, Iᵣ ∈ [symbol] ^{H×W×3}, the side-tuning CNN 156 (e.g., an EdgeNeXt-S model) may be used within the STA (e.g., the STAs 106 and 108) to extract multi-level pyramid features, where the ¼ level feature is equipped with the monocular depth estimation model's 154 features:

$${f}_{l}^{( i )} , {f}_{r}^{( i )} ∈ {ℝ}^{{C}_{i} \times \frac{H}{i} \times \frac{W}{i}} ,$$

i ∈ {4,8,16,32}. The EdgeNeXt-S model may be chosen for the side-tuning CNN 156 for its memory efficiency and because larger CNN backbones were shown to not yield additional benefits based on experimentation. When forwarding to the monocular depth estimation model 154, the image may be first resized to be divisible by 14, to be consistent with its pretrained patch size. The STA weights may be shared when applied to Iₗ, Iᵣ (e.g., the weights of the STAs 106 and 108 may be shared).

Returning to FIG. 1B, the first STA 106 may generate a right feature map

$${f}_{r}^{( 4 )}$$

for the right image 102 and the second STA 108 may generate a left feature map

$${f}_{l}^{( 4 )}$$

for the left image

The right and left feature map

$${f}_{r}^{( 4 )} , {f}_{l}^{( 4 )}$$

may be defined as follows:

$${f}_{l}^{( 4 )} , {f}_{r}^{( 4 )} ∈ {ℝ}^{{C}_{4} \times \frac{H}{4} \times \frac{W}{4}}$$

Therefore, the side-tuning CNN 156 may be learned to adapt the ViT features (e.g., the monocular depth features from the monocular depth estimation model 154) to the stereo matching task. Subsequently, based on the right and left feature maps

$${f}_{r}^{( 4 )} , {f}_{l}^{( 4 )} ,$$

the initial hybrid cost volume V_{c} 112 may be determined. The initial hybrid cost volume V_{c} 112 may be based on a group correlation cost volume V_{gwc} and a concatenation cost volume V_{cat}.

For example, determining the group correlation cost volume V_{gwc} using the right and left feature maps may be based on:

$${V}_{g w c} ( g , d , h , w ) = 〈 {\hat{f}}_{l , g}^{( 4 )} ( h , w ) , {\hat{f}}_{r , g}^{( 4 )} ( h , w - d ) 〉$$

where \hat{f} denotes the L₂ normalized feature that is used for better training stability, [symbol] represents a dot product, g is the group index among the total G feature groups (e.g., G=8 feature groups) that the total features from the right and left feature maps are divided into, and d is the disparity index where

$$d ∈ \{ 1 , 2 , … , \frac{D}{4} \} ,$$

and D is the maximum pre-defined disparity. For instance, D is a predefined maximum disparity at the original input image resolution, which may be based on the focal length of the image capturing device and a user set minimum depth that the user selects to observe. For instance, D may be divided by 4 here, since the feature maps are all at the ¼ of the original image resolution as described above. As such, d may be iterated from 1 to

$$\frac{D}{4} ,$$

and at each d, a dot-product may be performed between the left grouped features (e.g., at [h, w]) and right grouped features (e.g., at [h, w−d]).

Similarly, using the right and left feature maps, the concatenation cost volume V_{cat} may be obtained based on:

$${V}_{cat} ( d , h , w ) = [ Conv ( {f}_{l}^{( 4 )} ( h , w ) , Conv ( {f}_{r}^{( 4 )} ) ( h , w - d ) ]$$

where [symbol] denotes concatenation along the channel dimension of the feature maps. For example, d may be iterated from 1 to

$$\frac{D}{4} ,$$

and at each d, a concatenation may be performed for the left grouped features (e.g., at [h, w]) and right grouped features (e.g., at [h, w−d]) features after one layer of convolution.

After obtaining the group correlation cost volume V_{gwc} and the concatenation cost volume V_{cat}, the initial hybrid cost volume V_{c} 112 may be determined based on concatenating the group correlation cost volume V_{gwc} and the concatenation cost volume V_{cat}. This may be shown by the below expression:

$${V}_{c} ( d , h , w ) = [ {V}_{ℊ wc} ( d , h , w ) , {V}_{cat} ( d , h , w ) ]$$

where V_{c} may be a four-dimensional (4D) data structure

$$( e . g . , {V}_{c} ∈ {ℝ}^{C \times \frac{D}{4} \times \frac{H}{4} \times \frac{W}{4}} ) .$$

For instance, V_{c} may have a channel dimension C, a disparity dimension

$$\frac{D}{4} ,$$

a height dimension

$$\frac{H}{4} ,$$

and a width dimension

$$\frac{W}{4} .$$

The denominator of the disparity, height, and width dimensions being “4” is =merely exemplary and may be based on the side-tuning CNN 156 (e.g., based on applying a 4×4 convolution with a stride of 4 to downscale the features from the image).

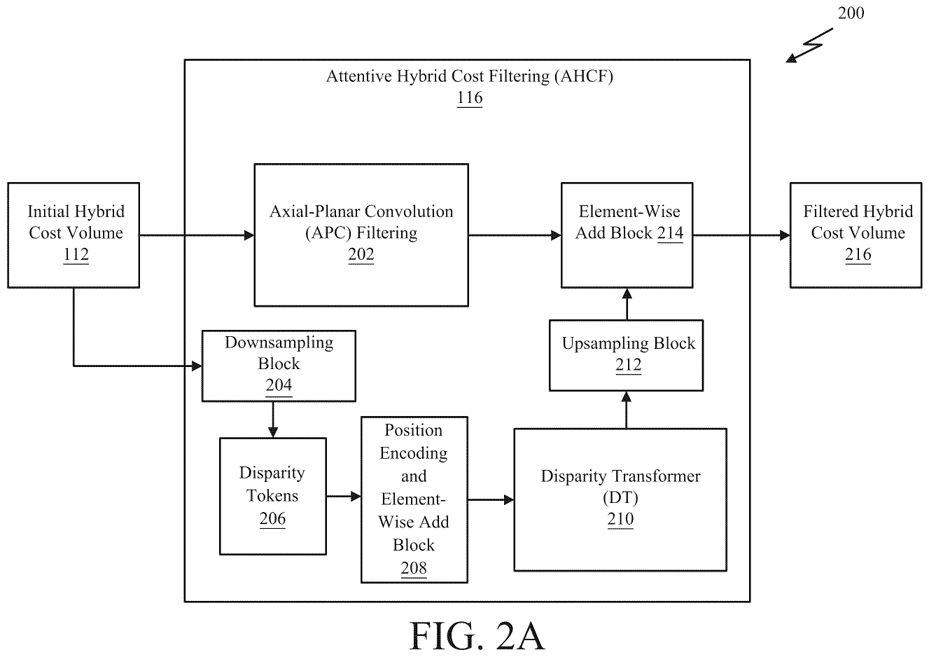

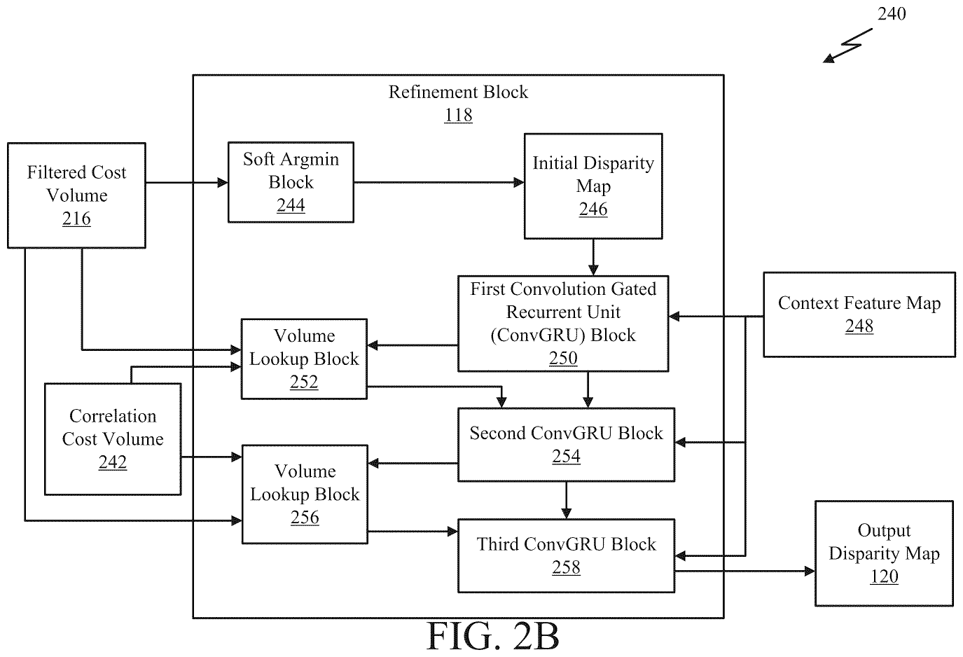

In other words, based on the right and left feature maps from the STAs 106 and 108, the group correlation cost volume V_{gwc} may be determined using a dot product of the right and left feature maps and the concatenation cost volume V_{cat} may be determined using a concatenation operation of the right and left feature maps. Subsequently, the concatenation cost volume V_{cat} and the group correlation cost volume V_{gwc} may be concatenated to obtain the initial hybrid cost volume 112. Thus, based on using the dot product and the concatenations, the group correlation cost volume V_{gwc} may harness the strengths of conventional correlation-based matching costs, which offers a diverse set of similarity measurement features from each group, and the concatenation cost volume V_{cat} may preserve the unary features including the rich monocular priors based on concatenating the left and right feature maps at a shifted disparity. The initial hybrid cost volume 112 may be provided to the AHCF 116, which is described in further detail in FIG. 2A.

To put it another way, embodiments of the present disclosure may utilize a hybrid cost volume construction. For example, given unary features at ¼ scale

$${f}_{l}^{4} , {f}_{r}^{4}$$

extracted from the STAs 106 and 108, the cost volume

$${V}_{C} ∈ {ℝ}^{C \times \frac{D}{4} \times \frac{H}{4} \times \frac{W}{4}}$$

may be constructed with a combination of group-wise correlation and concatenation:

$${V}_{gwc} ( ℊ , d , h , w ) = 〈 {\hat{f}}_{l , ℊ}^{( 4 )} ( h , w ) , {\hat{f}}_{r , ℊ}^{( 4 )} ( h , w - d ) 〉 ,$$

$${V}_{cat} ( d , h , w ) = [ Conv ( {f}_{l}^{( 4 )} ( h , w ) , Conv ( {f}_{r}^{( 4 )} ) ( h , w - d ) ] ,$$

$${V}_{C} ( d , h , w ) = [ {V}_{gwc} ( d , h , w ) , {V}_{cat} ( d , h , w ) ]$$

where \hat{f} denotes L₂ normalized feature for better training stability; [symbol] represents dot product; g ∈ {1, 2, . . . , G} is the group index among the total G=8 feature groups that the total features are evenly divided into;

$$d ∈ \{ 1 , 2 , … , \frac{D}{4} \}$$

is the disparity index. [symbol] denotes concatenation along channel dimension. The group-wise correlation V_{gwc} harnesses the strengths of conventional correlation-based matching costs, offering a diverse set of similarity measurement features from each group. V_{cat} preserves unary features including the rich monocular priors by concatenating left and right features at shifted disparity. In some examples, to reduce memory consumption, embodiments of the present disclosure may linearly downsize the unary feature dimension to 14 using a convolution of kernel size of 1 (e.g., weights are shared between

$${f}_{l}^{4} and {f}_{r}^{4} )$$

before concatenation.

FIG. 2A shows an overview 200 of using the AHCF 116 to generate a filtered hybrid cost volume 216, in accordance with an embodiment. For example, the initial hybrid cost volume 112 is provided to the APC filtering 202 and the downsampling block 204. Specifically, similar to the STAs 106-110, the AHCF 116 uses two branches that also utilizes the advantages of both a transformer architecture (e.g., the DT 210) and the CNN architecture (e.g., the APC filtering 202). For example, while 3D convolutions of kernel size 3×3×3 are commonly used for relatively small disparity sizes, it was observed that these 3D convolutions struggle with larger disparities when applied to high resolution images. In addition, due to the intensive memory consumption, it was observed to be impractical to naively increase the kernel size (e.g., setting the kernel size to 5×5×5 results in unmanageable memory usage on an 80 gigabyte (GB) graphics processing unit (GPU))

Therefore, the AHCF 116 uses two branches that separate the two convolutions: one over the spatial dimensions and the other over disparity. For example, the APC filtering 202 may perform convolutions over the spatial dimensions (e.g., the height (H) and the width (W)) of the initial hybrid cost volume 112. As such, based on processing the initial hybrid cost volume 112 using the APC filtering 202 and performing convolutions, the APC filtering 202 may generate an APC output. The APC filtering 202 may be an hourglass neural network such as a U-Net that performs 3D convolutions. For instance, the APC filtering 202 may include three downsampling blocks and three up-sampling blocks with residual connections. The APC filtering 202 may perform cost volume filtering of the initial hybrid cost volume 112 to generate the APC output.

In addition to generating the APC output, convolutions may further be performed over the disparity dimensions. For instance, disparity tokens 206 may be obtained based on using the downsampling block 204 to downsample the initial hybrid cost volume 112. For instance, the downsampling block 204 may apply a 3D convolution of kernel size 4×4×4 with a stride of 4 to downsize the initial hybrid cost volume 112. Then, the downsampled initial hybrid cost volume may be reshaped into a batch of token sequences, each with the length of the disparity. In other words, the downsampling block 204 may perform downsampling to obtain a smaller cost volume that is more manageable for the DT 210 to process. Thus, while the channel dimension might not change, the disparity, width, and height dimensions may change to be

$$\frac{D}{16} , \frac{W}{16} , and \frac{H}{16} .$$

Subsequently, the downsampled initial hybrid cost volume may be reshaped such that each disparity token 206 may be associated with a height and width, and may have the dimensions of the channel (C) and the disparity. For instance, for a 512×512 image, there may be 1024 disparity tokens and each token would have a length of the disparity dimension and include the channel features from the channel dimension.

Afterwards, the position encoding and element-wise add block 208 may perform position encoding for the disparity tokens 206. For instance, the disparity tokens 206 might not have any positioning information (e.g., positioning information indicating the relationship between the disparity tokens 206 and locational information from the original left and/or right images 102, 104). As such, the position encoding and element-wise add block 208 may include or add positioning information associated with the original left and/or right images 102, 104 to the disparity tokens 206. Subsequently, the disparity tokens 206 with the positioning information may be provided to the DT 210.

The DT 210 may be any type of transformer architecture. For instance, in some embodiments, the DT 210 may include one or more layers and each layer may include a self-attention block, an add & norm block, a feed forward block, and another add & norm block. In some instances, the DT 210 may include four layers and each layers may include the four blocks described above. The DT 210 may process the disparity tokens 206 with the positioning information and generate a DT output.

In some examples, each layer of the DT 210 may include a flash self-attention block such as the flash self-attention block that is described in Dao et al. “FlashAttention: Fast and memory-efficient exact attention with io-awareness.” In Proceedings of Neural Information Processing Systems (NeurIPS), 35:16344-16359, 2022, which is incorporated by reference herein. By using the flash self-attention block, additional advantages may be achieved such as reducing memory consumption and obtaining a faster compute speed. For instance, the flash self-attention block may include and/or utilize a separate library that results in a more advanced implementation of the Foundational Stereo Model.

The upsampling block 212 may perform upsampling of the DT output. For instance, given the downsampling block 204 and prior to performing an element-wise add, the upsampling block 212 may perform upsampling such that the upsampled DT output is the same size as the APC output from the APC filtering 202. For instance, the upsampling block 212 may perform trilinear interpolation. Subsequently, the element-wise add block 214 sums the APC Output from the APC filtering 202 with the upsampled DT output to generate the filtered hybrid cost volume 216, which is output from the AHCF 116.

In other words, the AHCF 116 may include the APC filtering 202 and the DT 210. The APC filtering 202 may be and/or include an hourglass network comprising 3D convolutions, with three downsampling blocks and three up-sampling blocks with residual connections. The APC filtering 202 may be leveraged for cost volume filtering. While 3D convolutions of kernel size 3×3×3 are commonly used for relatively small disparity sizes, it was observed that it struggles with larger disparities when applied to high resolution images, especially since the disparity dimension is expected to model the probability distribution for the initial disparity prediction. However, it is impractical to naively increase the kernel size, due to the intensive memory consumption. Therefore, the AHCF 116 and the APC filtering 202 utilizes APC, which decouples a single 3×3×3 convolution into two separate convolutions: one over spatial dimensions (kernel size Kₛ×Kₛ×1) and the other over disparity (1×1×K_{d}), each followed by batch normalization (BatchNorm) and rectified linear unit (ReLU) operations. The AHCF 116 may be regarded, in some embodiments, as a 3D version of Separable Convolution with the difference that the spatial and disparity dimensions are separated without subdividing the channel into groups, which sacrifices representation power. The disparity dimension may be specially treated due to its uniquely encoded feature comparison within the cost volume. The APC may be used wherever possible in the hourglass network except for the downsampling and upsampling layers.

Regarding the DT 210, while conventional approaches introduced a transformer architecture to unary feature extraction step to scale up stereo training, the cost filtering process is often overlooked, which remains an essential step in achieving accurate stereo matching by encapsulating correspondence information. Therefore, the DT 210 is introduced to further enhance the long-range context reasoning within the four-dimensional (4D) cost volume. Given the initial hybrid cost volume V_{c} 112, the AHCF 116 applies a 3D convolution of kernel size 4×4×4 with stride 4 to downsize the cost volume. Then, the AHCF 116 reshapes the volume into a batch of token sequences (e.g., the disparity tokens 206 that are obtained based on the downsampling block 204), each with length of disparity. Position encoding is applied before feeding it to a series of transformer encoder blocks (e.g., four transformer encoder blocks), where FlashAttention may be leveraged to perform multi-head self-attention. The process may be written as:

$${Q}_{0} = PE ( R ( {Conv}_{4 \times 4 \times 4} ( {V}_{C} ) ) ) ∈ ℝ ( \frac{H}{16} \times \frac{W}{16} ) \times C \times \frac{D}{16}$$

$$MultiHead ( \text{} Q , \text{} K , \text{} V ) = [ {head}_{1} , … , {head}_{h} ] {W}_{O} where {head}_{i} = FlashAttention ( {Q}_{i} , {K}_{i} , {V}_{i} )$$

$${Q}_{1} = Norm ( MultiHead ( {Q}_{0} , {Q}_{0} , {Q}_{0} ) + {Q}_{0} )$$

$${Q}_{2} = Norm ( FFN ( {Q}_{1} ) + {Q}_{1} )$$

where R (·) denotes reshape operation; PE(·) represents position encoding; [symbol] denotes concatenation along the channel dimension; W₀ is linear weights. The number of heads is h=4 in some examples. Finally, the output from the DT 210 is up-sampled (e.g., using the upsampling block 212) to the same size as initial hybrid cost volume V_{c} 112 using trilinear interpolation and summed with the hourglass output (e.g., the output from the APC filtering 202) using the element-wise add block 214 to obtain the filtered hybrid cost volume 216. The filtered hybrid cost volume 216 is then output from the AHCF 116.

Returning to FIG. 1B, three inputs are provided the refinement block 118. The first input may be the output of the AHCF 116, which may be the filtered hybrid cost volume 216 that is described above. In addition, the dot-product block 114 may perform a dot product of the left and right feature maps from the right and left images 102, 104 to generate a correlation cost volume V_{corr}. For example, a dot product may be performed on the right feature map from the first STA 106 and the left feature map from the second STA 108 to generate the correlation cost volume V_{corr}.

In addition, the third STA 110 may be used to extract context features from one of the images (e.g., the second image 104 shown in FIG. 1B). For instance, the third STA 110 may include a CNN (e.g., a context network) that may be similar to the side-tuning CNN 156 of the STAs 106 and 108, a monocular depth estimation model that may be similar (and/or the same) as the monocular depth estimation model 154 of the STAs 106 and 108, and a concatenation block that may be the same as the concatenation block 158 of the STAs 106 and 108. However, the side-tuning CNNs 156 of the STAs 106 and 108 may share weights during training whereas the CNN of the third STA 110 may be trained with different weights. The CNN of the third STA 110 may generate context features based on the second image 104. For instance, even though the training is different, the CNN of the third STA 110 may function similarly to the side-tuning convolutional neural network 156 of FIG. 1C for the STAs 106 and 108. But, instead of generating CNN pyramid features, the CNN of the third STA 110 may generate context features associated with the second image 104. The context features may be provided to a concatenation block. Furthermore, the monocular depth estimation model of the third STA 110 may generate monocular depth features, which may also be provided to the concatenation block. The concatenation block may concatenate the monocular depth features and the context features to generate a context feature map

$${f}_{c}^{( 4 )} .$$

In other words, whereas the second STA 108 utilizes a monocular depth estimation model 154 and a side-tuning CNN 156 to generate a left feature map

$${f}_{l}^{( 4 )} ,$$

the concatenation block of the third STA 110 may use the output from the monocular depth estimation model and the output from the CNN to generate the context feature map

$${f}_{c}^{( 4 )} .$$

The context feature map

$${f}_{c}^{( 4 )}$$

may be provided as the third input to the refinement block 118. For instance, the context feature map

$${f}_{c}^{( 4 )}$$

may be used to initialize the hidden state of the ConvGRUs at each iteration, which effectively guides the iterative process with progressively refined contextual information.

In other words, in some embodiments, the third STA 110 may be used to extract context feature, with the difference that the CNN module of the third STA 110 may be designed with a sequence of residual blocks and down-sampling layers. The third STA 110 may generate context features of multiple scales:

$${f}_{c}^{( i )} ∈ {ℝ}^{{C}_{i} \times \frac{H}{i} \times \frac{W}{i}} ,$$

i ∈ {4,8,16}. The context feature map f_{c} may participate in initializing the hidden state of the ConvGRU blocks described below and inputting to the ConvGRU block at each iteration. This may effectively guide the iterative process with progressively refined contextual information.

In some examples, the third STA 110 might not include a monocular depth estimation model and may instead may receive an input from the second STA 108. Specifically, the monocular depth estimation model 154 of the second STA 108 may provide monocular depth features to the concatenation block of the second STA 108 and also to the concentration block of the third STA 110. The concatenation block of the third STA 110 may concatenate the monocular depth features and the context features to generate the context feature map

$${f}_{c}^{( 4 )} .$$

As such, the refinement block 118 obtains three inputs—the context feature map

$${f}_{c}^{( 4 )} ,$$

the correlation cost volume V_{corr}, and the filtered hybrid cost volume 216. Based on processing the three inputs, the refinement block 118 outputs an output disparity map 120. The refinement block 118 is described further in FIG. 2B.

FIG. 2B shows an overview 240 of using the refinement block 118 to generate the output disparity map 120, in accordance with an embodiment. For instance, the filtered cost volume 216, the correlation cost volume 242, and the context feature map 248 are provided as input to the refinement block 118. Initially, the soft argmin block 244 may perform a soft argmin function to generate the initial disparity map 246 from the filtered cost volume 216. For example, the expression to produce the initial disparity map 246 is shown below:

$${d}_{0} = {\sum }_{d = 0}^{\frac{D}{4} - 1} d \cdot Soft max ( {V}_{C}^{′} ) ( d )$$

where d₀ is the initial disparity map 246 and is at a ¼ scale of the original image resolution of the right and left images 102, 104, Softmax is a Softmax operation, and

$${V}_{C}^{′}$$

is the filtered cost volume 216.

Following, the refinement block 118 may perform iterative refinement of the initial disparity map 246. For instance, the first ConvGRU block 250 may obtain the initial disparity map 246 and the context feature map 248. The first ConvGRU block 250 may perform a convolution GRU operation and process the initial disparity map 246 and the context feature map 248 to generate a first refined disparity map. The first refined disparity map may be provided to the second ConvGRU block 254 and the volume lookup block 252.

The volume lookup block 252 may utilize the first refined disparity map from the first ConvGRU block 250, the filtered cost volume 216, and the correlation cost volume 242 to generate two feature vectors. For instance, the volume lookup block 252 may probe the filtered cost volume 216 and the correlation cost volume 242 based on the first refined disparity map to generate two feature vectors—a first feature vector associated with the filtered cost volume 216 and a second feature vector associated with the correlation cost volume 242. The volume lookup block 252 may provide the two feature vectors to the second ConvGRU block 254.

The second ConvGRU block 254 may process the two feature vectors, the first refined disparity map, and the context feature map 248 to generate a second refined disparity map. Then, similar to the first ConvGRU block 250, the second refined disparity map may be provided to the third ConvGRU block 258 and the volume lookup block 256. The volume lookup block 256 may operate similarly to the volume lookup block 252 and two feature vectors are provided to the third ConvGRU block 258.

The third ConvGRU block 258 may process the two feature vectors, the context feature map 248 and the second refined disparity map to generate the output disparity map 120. While only three ConvGRU blocks 250, 254, and 258 are shown in FIG. 2B, the refinement block 118 may include any number of ConvGRU blocks (e.g., thirty-two ConvGRU blocks). For example, the refinement block 118 may include any number of refinement iterations (e.g., thirty-two refinement iterations). For instance, each iteration may include using a ConvGRU block to generate a refined disparity map based on the initial disparity map 246 or a previous refined disparity map, the context feature map 248, and the two feature vectors from the volume lookup block (e.g., the volume lookup blocks 252 and 256) until the last iteration generates an output disparity map 120 that is provided as output from the Foundational Stereo Model.

In other words, given the initial disparity map do 246, the refinement block 118 may perform iterative GRU updates to progressively refine the disparity, which helps to avoid local optimum and accelerate convergence. In general, the k-th update may be formulated as:

$${V}_{corr} ( {w}^{′} , h , w ) = 〈 {f}_{l}^{( 4 )} ( h , w ) , {f}_{r}^{( 4 )} ( h , {w}^{′} ) 〉$$

$${F}_{V} ( h , w ) = [ {V}_{C}^{′} ( {d}_{k} , h , w ) , {V}_{corr} ( w - {d}_{k} , h , w ) ]$$

$${x}_{k} = [ C o n {v}_{v} ( {F}_{V} ) , C o n {v}_{d} ( {d}_{k} ) , {d}_{k} , c ]$$

$${z}_{k} = σ ( C o n {v}_{z} ( [ {h}_{k - 1} , {x}_{k} ] ) )$$

$${r}_{k} = σ ( C o n {v}_{r} ( [ {h}_{k - 1} , {x}_{k} ] ) )$$

$${\hat{h}}_{k} = tanh ( C o n {v}_{h} ( [ {r}_{k} ⊙ {h}_{k - 1} , {x}_{k} ] ) )$$

$${h}_{k} = ( 1 - {z}_{k} ) ⊙ {h}_{k - 1} + {z}_{k} ⊙ {\hat{h}}_{k}$$

$${d}_{k + 1} = {d}_{k} + C o n {v}_{Δ} ( {h}_{k} )$$

where ⊙ denotes element-wise product; σ denotes sigmoid;

$${V}_{c o r r} ∈ {ℝ}^{\frac{W}{4} \times \frac{H}{4} \times \frac{W}{4}}$$

is the pair-wise correlation volume; F_{V} represents the looked up volume features using latest disparity; c=ReLU (f_{c}) encodes the context feature from left image, including STA adapted features that are described above, which effectively guides the refinement process to leverage the rich monocular priors.

In some embodiments, three levels of GRU blocks may be used to perform coarse-to-fine hidden state update in each iteration, where the initial hidden states are produced from context features

$${h}_{0}^{( i )} = tanh ( {f}_{c}^{( i )} ) ,$$

i ∈ {4,8,16}. At each level, an attention-based selection mechanism may be leveraged to capture information at different frequencies. Further, the current iteration's disparity map dₖ may be up-sampled to the full resolution using convex sampling.

During training, the Foundational Stereo Model may be trained utilizing one or more loss functions such as trained using following objective:

$$L = {\vert {d}_{0} - \overline{d} \vert}_{smooth} + {\sum }_{k = 1}^{K} {γ}^{K - k} ‖ {d}_{k} - \overline{d} {‖}_{1}$$

where d̅ represents the ground-truth disparity, |·|smooth denotes the smooth L₁ loss, k is the iteration number, γ is a parameter such as 0.9, and exponentially increasing weights may be applied to supervise the iteratively refined disparity.

For instance, the first term (e.g., the smooth L1 loss (|d₀-d̅|ₛₘₒₒₜₕ) may be configured to combine the strengths of two common loss functions: Mean Squared Error (MSE) and Mean Absolute Error (MAE). This may work as follows:
1. Behavior for small differences: When the difference between the predicted value and the actual value (residual) is small, the smooth L1 loss may behave similar to the MSE. For instance, the smooth L1 loss may square the residual, which makes it more sensitive to small errors and encourages finer adjustments.
2. Behavior for large differences: When the residual becomes large, the smooth L1 loss may behave similar to MAE. The smooth L1 loss may grow linearly with the residual, making it less sensitive to outliers as compared to MSE, which would grow quadratically.

The 2^{nd} terms

$$( {Σ}_{k = 1}^{K} {γ}^{K - k} ‖ {d}_{k} - \overline{d} {‖}_{1} )$$

performs directly L1 loss (absolute) between prediction (dₖ) and ground-truth (d̅). Both the smooth loss term (e.g., the smooth L1 loss) and the direct loss term (e.g., the direct L1 lose between the prediction and the ground-truth) may be averaged over each pixel.

Based on the above objective, the Foundational Stereo Model may be trained. In some examples, during training, the monocular depth estimation models 154 of the first STA 106 and the second STA 108 may be frozen. However, the other aspects of the Foundational Stereo Model such as, but not limited to, the side-tuning CNNs 156 of the first STA 106 and the second STA 108, the third STA 110, the AHCF 116 (e.g., the APC filtering 202, the upsampling block 212, the downsampling block 204, and/or the DT 210), and/or the refinement block 118 (e.g., the first through third ConvGRU blocks 250, 254, and 258) may be trained based on the above objective. Additionally, and/or alternatively, the side-tuning CNN 156 of the STAs 106 and 108 may share weights during training.

Among other benefits and advantages, embodiments of the present disclosure provide a Foundational Stereo Model that includes STAs 106 and 108 to generate an initial hybrid cost volume 112. The STAs 106 and 108 utilize a monocular depth estimation model 154 and a side-tuning CNN 156. Furthermore, the initial hybrid cost volume 112 is generated based on a group correlation cost volume V_{gwc} and a concatenation cost volume V_{cat}. Additionally, and/or alternatively, the Foundational Stereo Model further includes an AHCF 116 that generates a filtered hybrid cost volume 216 based on the initial hybrid cost volume 112. The AHCF 116 includes a first branch for the spatial dimensions (e.g., APC filtering 202) and a second branch for the disparity dimensions (e.g., the generation of the disparity tokens 206 and the DT 210). Additionally, and/or alternatively, the Foundational Stereo Model also includes a refinement block 118 that utilizes ConvGRU blocks 250, 254, and 258 to iteratively refine an initial disparity map 246 to generate an output disparity map 120.

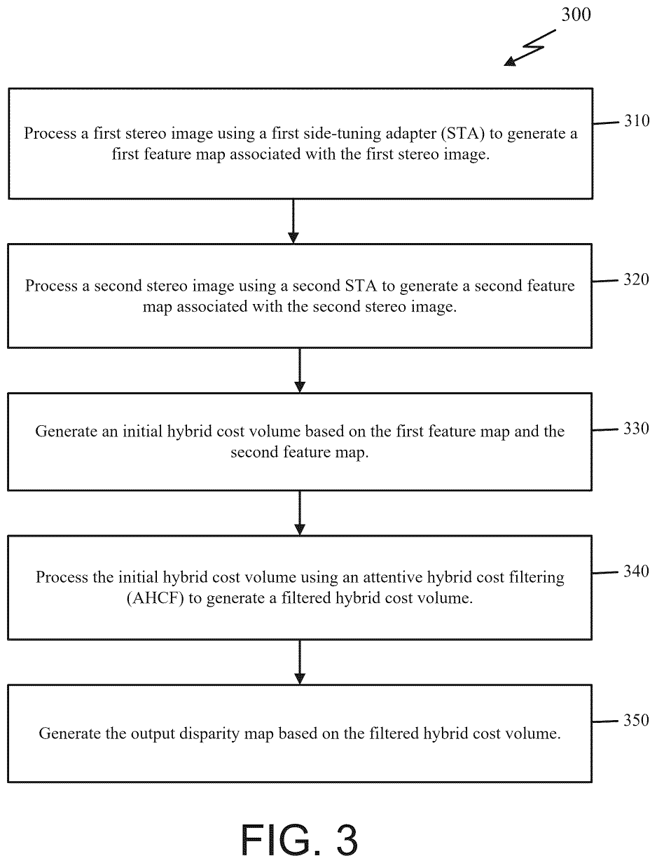

FIG. 3 provides a flow diagram illustrating a method 300 for using a Foundational Stereo Model to generate an output disparity map, in accordance with an embodiment. Each block of method 300, described herein, comprises a computing process that may be performed using any combination of hardware, firmware, and/or software. For instance, various functions may be carried out by a processor executing instructions stored in memory. The method 300 may also be embodied as computer-usable instructions stored on computer storage media. The method 300 may be provided by a standalone application, a service or hosted service (standalone or in combination with another hosted service), or a plug-in to another product, to name a few. In addition, method 300 is described, by way of example, with respect to the overviews 100, 150, 200, and/or 240. However, the method 300 may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

At step 310, a first stereo image is processed using a first STA 106 to generate a first feature map associated with the first stereo image. In an embodiment, the first STA 106 comprises a first monocular depth estimation model and a first side-tuning convolutional neural network (CNN). The generating the first feature map comprises: processing the first stereo image using the first monocular depth estimation model to generate monocular depth features; processing the first stereo image using the first side-tuning CNN to generate CNN pyramid features; and concatenating the monocular depth features and the CNN pyramid features to generate the first feature map.

At step 320, a second stereo image is processed using a second STA 108 to generate a second feature map associated with the second stereo image. In an embodiment, the second STA 108 comprises a second monocular depth estimation model and a second side-tuning CNN. The generating the second feature map comprises: processing the second stereo image using the second monocular depth estimation model to generate second monocular depth features; processing the second stereo image using the second side-tuning CNN to generate second CNN pyramid features; and concatenating the second monocular depth features and the second CNN pyramid features to generate the second feature map.

At step 330, an initial hybrid cost volume 112 is generated based on the first feature map and the second feature map. In an embodiment, generating the initial hybrid cost volume comprises: generating a group correlation cost volume based on the first feature map and the second feature map; generating a concatenation cost volume based on the first feature map and the second feature map; and concatenating the group correlation cost volume and the concatenation cost volume to obtain the initial hybrid cost volume. In an embodiment, generating the group correlation cost volume comprises: performing a dot product of the first feature map and the second feature map to obtain the group correlation cost volume. In an embodiment, generating the concatenation cost volume comprises: concatenating the first feature map and the second feature map to obtain the concatenation cost volume.

At step 340, the initial hybrid cost volume 112 is processed using an attentive hybrid cost filtering (AHCF) 116 to generate a hybrid cost volume. In an embodiment, the AHCF 116 comprises an axial-planar convolution (APC) filtering block 202 and a disparity transformer (DT) 210. The processing the initial hybrid cost volume using the AHCF 116 to generate the filtered hybrid cost volume comprises: filtering the initial hybrid cost volume using the APC filtering block 202 to generate an APC output; processing disparity tokens associated with the initial hybrid cost volume using the DT 210 to obtain a DT output; and generating the filtered hybrid cost volume based on the APC output and the DT output.

In an embodiment, the APC filtering block 202 comprises an hourglass neural network, and wherein filtering the initial hybrid cost volume using the APC filtering block 202 to generate the APC output comprises performing convolution operations using the hourglass neural network to obtain the APC output from the initial hybrid cost volume. In an embodiment, processing the disparity tokens to obtain the DT output comprises: downsampling the initial hybrid cost volume to obtain a downsampled initial hybrid cost volume; generating the disparity tokens based on reshaping the downsampled initial hybrid cost volume; and processing the disparity tokens using the DT to generate the DT output. Further, generating the filtered hybrid cost volume based on the APC output and the DT output comprises: upsampling the DT output to obtain an upsampled DT output; and generating the filtered hybrid cost volume based on the APC output and the upsampled DT output. In an embodiment, processing the disparity tokens using the DT to generate the DT output further comprises: encoding positional information into the disparity tokens to obtain encoded disparity tokens; and processing the encoded disparity tokens to generate the DT output. In an embodiment, generating the filtered hybrid cost volume based on the APC output and the DT output comprises: performing an element-wise add to the APC output and the DT output to obtain the filtered hybrid cost volume.

At step 350, the output disparity map 120 is generated based on the filtered hybrid cost volume. In an embodiment, generating the output disparity map based on the filtered hybrid cost volume comprises: generating an initial disparity map based on the filtered hybrid cost volume; performing one or more convolution gated recurrent unit (ConvGRU) operations to generate one or more intermediate disparity maps based on the initial disparity map; and generating the output disparity map based on the one or more intermediate disparity maps.

In an embodiment, generating the one or more first intermediate disparity maps comprises: performing a first ConvGRU operation, from the one or more ConvGRU operations to generate a first intermediate disparity map from the one or more intermediate disparity maps; generating a first feature vector based on the filtered hybrid cost volume and the first intermediate disparity map; generating a second feature vector based on the first intermediate disparity map and a correlation cost volume, wherein the correlation cost volume is generated based on performing a dot-product of the first feature map and the second feature map; and performing a second ConvGRU operation, from the one or more ConvGRU operations, to generate a second intermediate disparity map, from the one or more intermediate disparity maps, based on the first intermediate disparity map, the first feature vector, and the second feature vector, and wherein generating the output disparity map is based on the second intermediate disparity map.

In an embodiment, the method 300 further includes processing the second stereo image using a convolutional neural network to generate context features; and concatenating the context features and monocular depth features from a monocular depth estimation model to obtain a context feature map, and wherein performing the one or more ConvGRU operations to generate the one or more intermediate disparity maps is further based on the context feature map.

In an embodiment, at least one of steps 310-350 and/or the further steps described above for method 300 are performed on a server or in a data center to generate the output disparity map, and the output disparity map is streamed to a user device. In an embodiment, at least one of steps 310-350 and/or the further steps described above for method 300 is performed within a cloud computing environment. In an embodiment, at least one of steps 310-350 and/or the further steps described above for method 300 is performed for training, testing, or certifying a neural network employed in a machine, robot, or autonomous vehicle. In an embodiment, at least one of steps 310-350 and/or the further steps described above for method 300 is performed on a virtual machine comprising a portion of a graphics processing unit.

In some examples, embodiments of the present disclosure describe a Foundational Stereo Model, which is a large foundation model for stereo depth estimation that achieves strong zero-shot generalization without per-domain fine-tuning. Embodiments of the present disclosure include a side-tuning feature backbone (e.g., the STAs 106, 108, and 110) that adapts internet-scale rich priors from a model (e.g., monocular depth estimation model 154) that is trained on real monocular images to the stereo setup. To effectively leverage these rich monocular priors embedded into the 4D cost volume, embodiments of the present disclosure further include an AHCF 116, consisting of 3D APC filtering 202 and a DT 210. The AHCF 116 may decouple the standard 3D convolution into two separate spatial-oriented and disparity-oriented 3D convolutions, enhancing the receptive fields for volume feature aggregation. The DT 210 may perform self-attention over the entire disparity space within the cost volume, providing long range context for global reasoning. Together, these may significantly enhance the representation, leading to better disparity initialization, as well as more powerful features for the subsequent iterative refinement process (e.g., the refinement block 118).

### EXEMPLARY COMPUTING SYSTEM

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

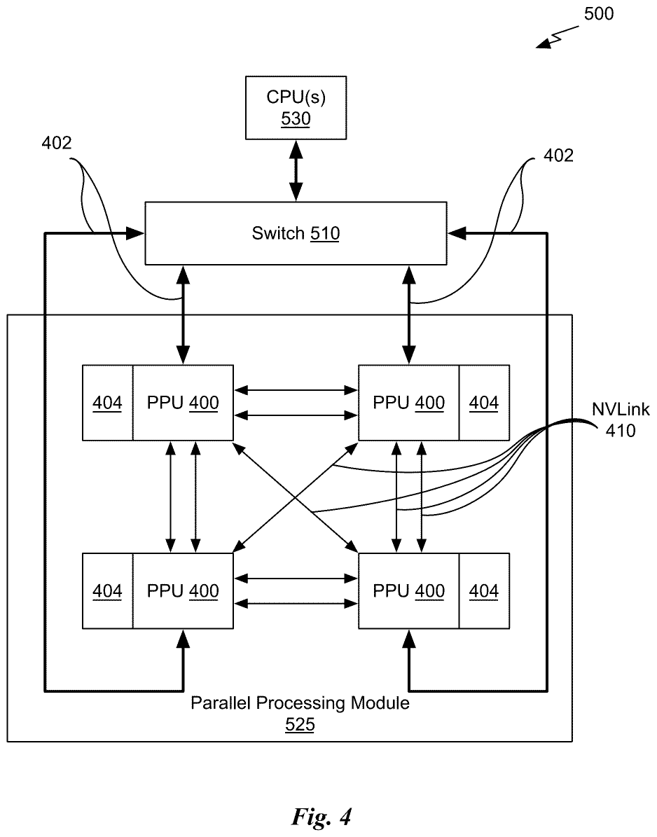

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Trec Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

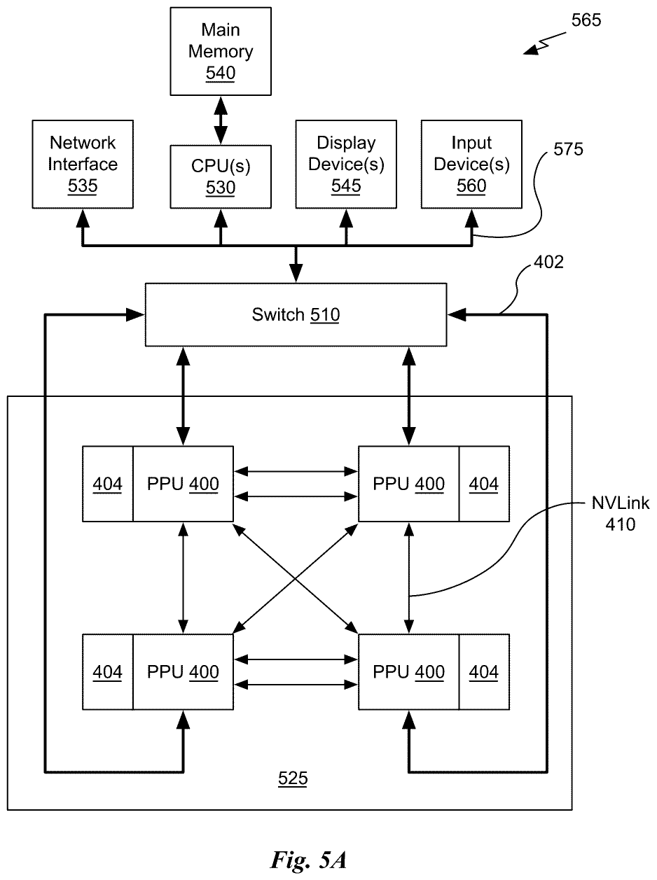

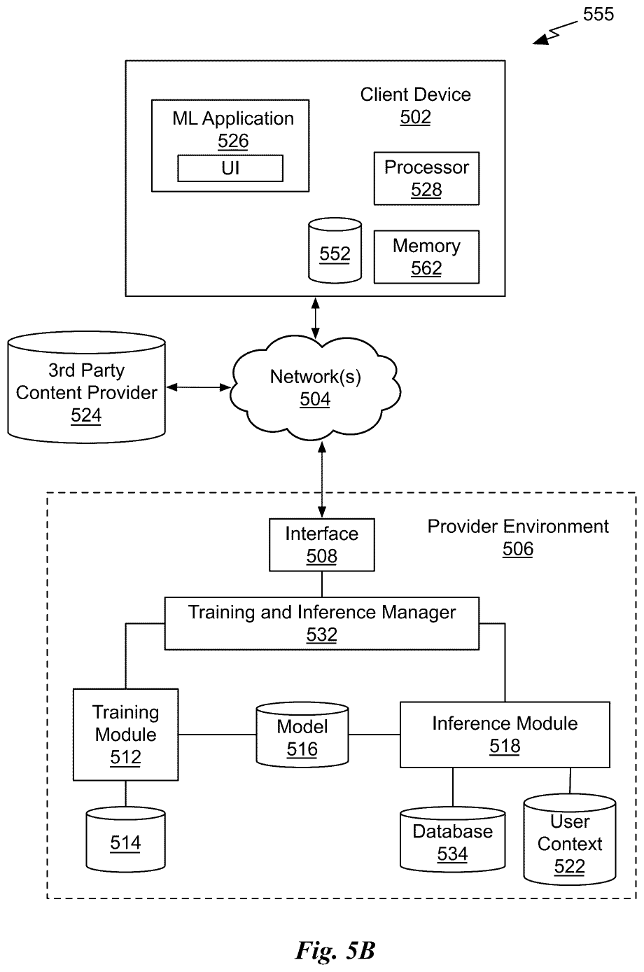

FIG. 5A illustrates an exemplary system 565 in which the various architecture and/or functionality of the various previous embodiments may be implemented. The exemplary system 565 may be configured to implement the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

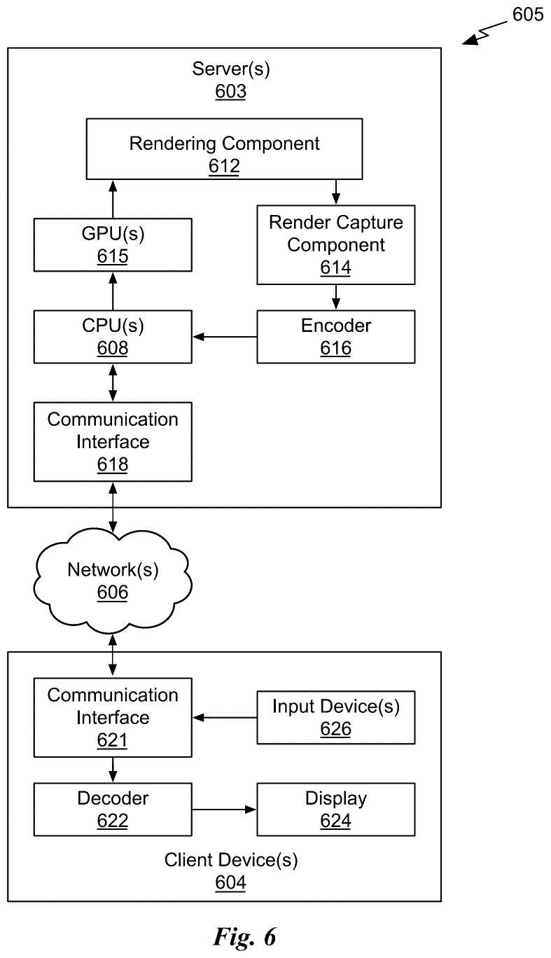

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units-such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

Systems and methods are disclosed herein for generating synthetic data (e.g., synthetic datasets) for training stereo foundation models. For example, it was shown that synthetic datasets that are obtained based on conventional approaches typically are limited in their rendering realism, scenario diversity, scene layout realism, data scale, and/or physical modeling complexity (e.g., reflections and camera parameter diversity).

As such, embodiments of the present disclosure describe a process for generating a large-scale synthetic training dataset for stereo models. The synthetic training dataset generated by embodiments of the present disclosure may account for crucial stereo matching challenges such as reflections, low-texture surfaces, and/or severe occlusions. Additionally, and/or alternatively, embodiments of the present disclosure may perform domain randomization to augment dataset diversity, including parameters such as, but not limited to, random stereo baseline, focal length, camera perspectives, lighting conditions, and/or object configurations. Furthermore, high-quality 3D assets with abundant textures and path-tracing rendering may be leveraged by embodiments of the present disclosure to enhance realism in rendering and layouts.

While synthetic data generation may, in theory, produce unlimited amounts of data and achieve large diversity through randomization, ambiguities may be inevitably introduced, which may confuse the learning process. To eliminate such samples, embodiments of the present disclosure may be configured to perform an automatic iterative self-curation process that generates synthetic datasets for training stereo models (e.g., the Foundational Stereo Model described above) and utilize the trained stereo models to curate newly generated synthetic datasets.

As will be described in further detail below, embodiments of the present disclosure describe a data generation pipeline for generating large-scale synthetic datasets and further describe an iterative self-curation process for the generation of the large-scale synthetic datasets. Through extensive experiments, the data generation pipeline and the generated large-scale synthetic datasets were shown to significantly benefit the training of large-scale foundation models for stereo matching, including the Foundational Stereo Model described above.

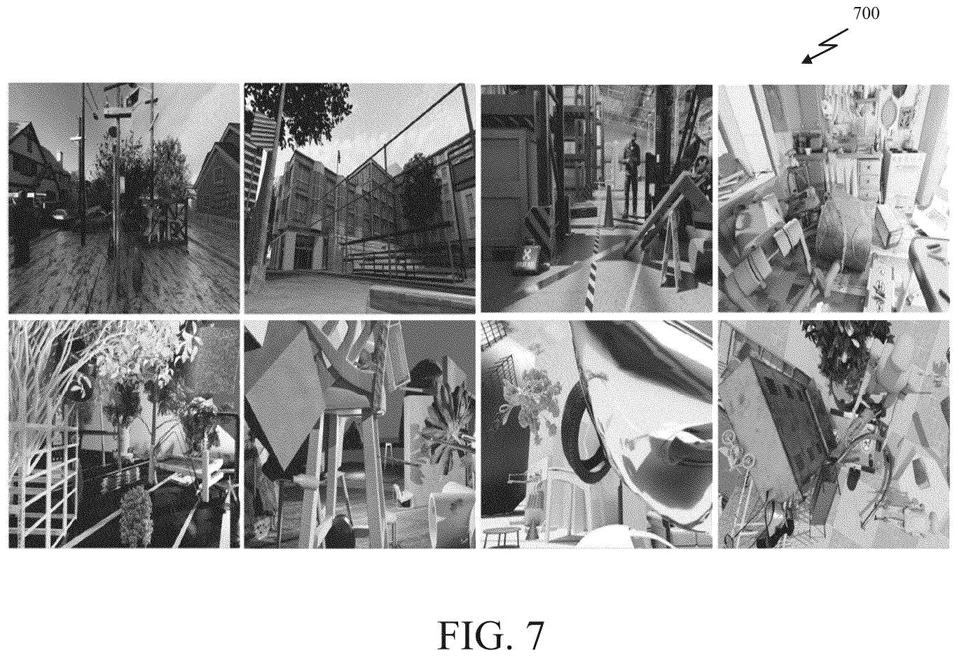

FIG. 7 shows exemplary synthetic images 700 that were generated using embodiments of the present disclosure. For instance, the eight synthetic images 700 shown in FIG. 7 may be synthetic stereo images that show structured indoor/outdoor scenes, as well as more randomized scenes with challenging flying objects and higher geometry and texture diversity.

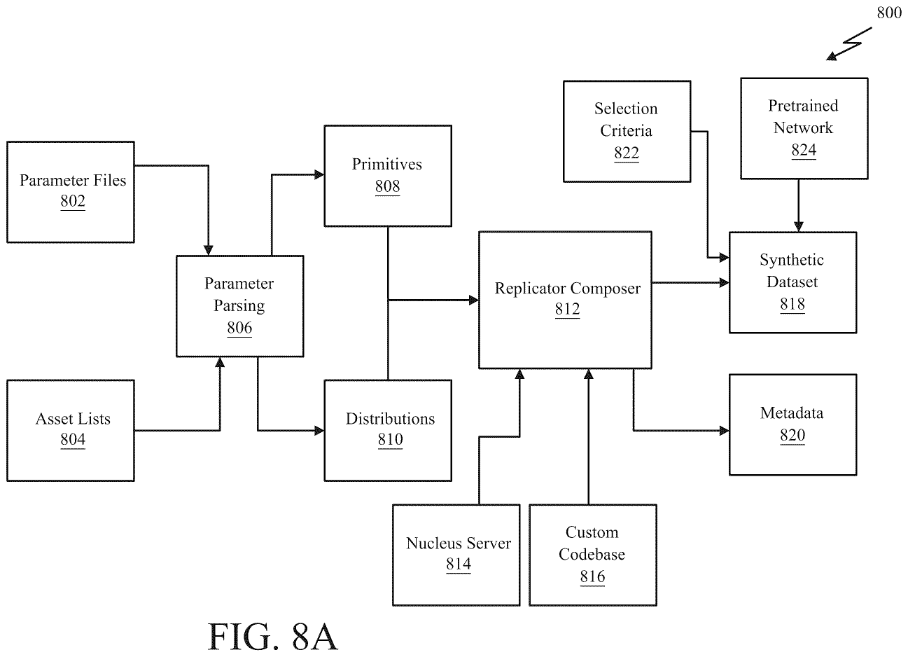

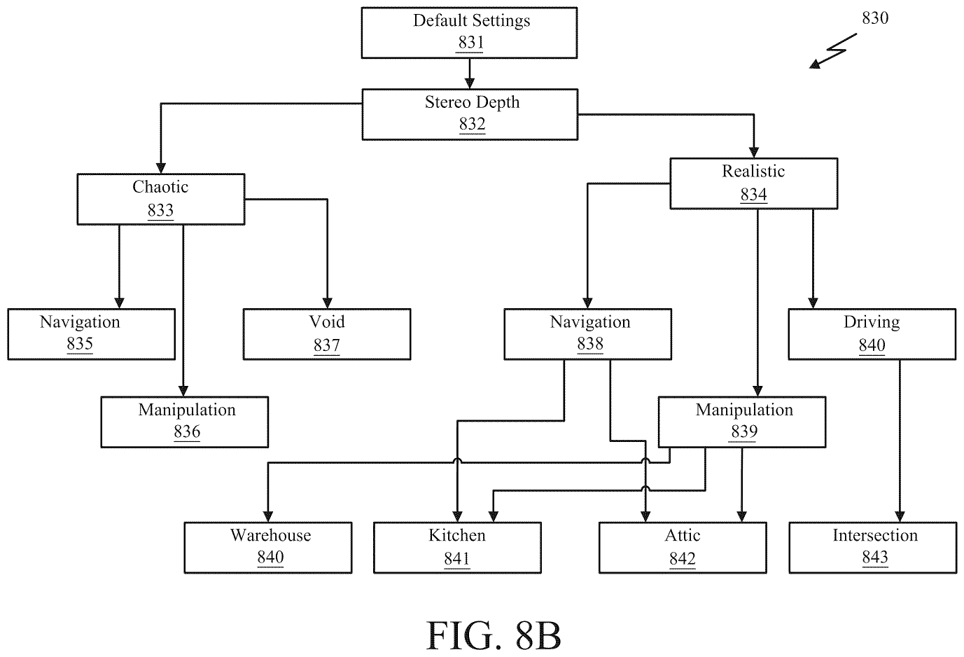

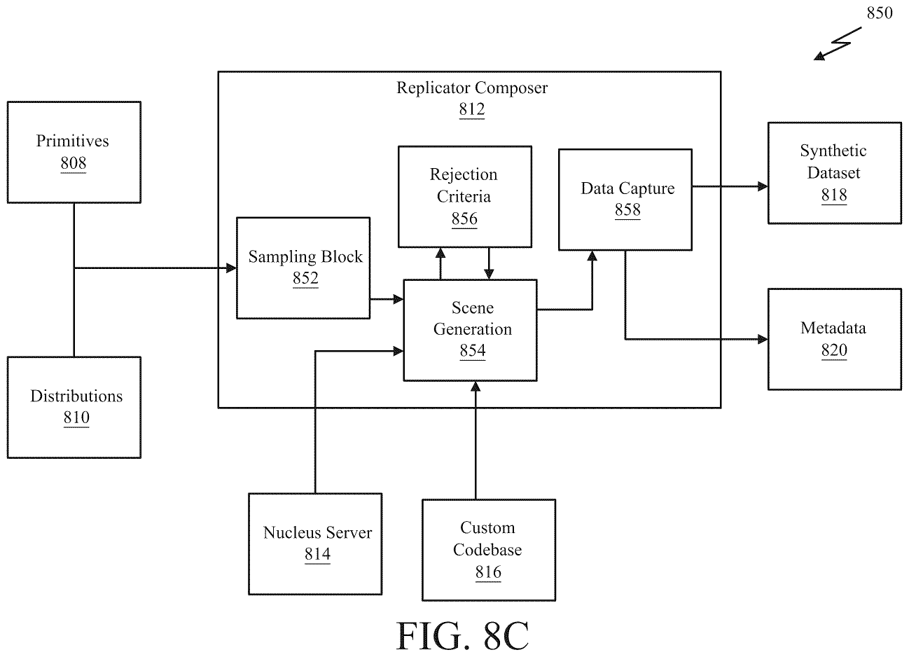

FIG. 8A shows an overview 800 of a synthetic generation process to generate a training dataset (e.g., synthetic dataset 818) comprising the synthetic images, in accordance with an embodiment. Each block of the overview 800, described herein, may comprise a computing process that may be performed using any combination of hardware, firmware, and/or software. For instance, various functions may be carried out by a processor executing instructions stored in memory. The overview 800 may also be embodied as computer-usable instructions stored on computer storage media. The overview 800 may be provided by a standalone application, a service or hosted service (standalone or in combination with another hosted service), or a plug-in to another product, to name a few. In addition, the overview 800 is described, by way of example, with respect to a computing system and/or platform. However, this overview 800 may additionally or alternatively be executed by any one system, or any combination of systems, including, but not limited to, those described herein. Furthermore, persons of ordinary skill in the art will understand that any system that performs the overview 800 is within the scope and spirit of embodiments of the present disclosure.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

In addition, one or more computing systems or computing platforms may be used to perform one or more blocks of the overview 800. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location.

For instance, parameter files 802 and asset lists 804 may be obtained. The parameter files 802 may indicate parameters for the replicator composer 812 to use to generate scenes. For example, the parameter files 802 may be any type of file and/or document (e.g., a JAVASCRIPT Object Notation (JSON) file) that includes parameters such as key-value pairs. By using key-value pairs, randomization of the scenes generated by the replicator composer 812 may be achieved. For example, the parameter files 802 may indicate parameters associated with objects to be generated within the scenes (e.g., object counts such as how many objects are to be placed within the scene, materials of the object, time height) and camera information (e.g., positional information regarding the placement of the camera(s) within the scenes). For instance, the camera information may indicate camera coordinates and/or orientations such as parameters indicating a range or distribution of positional coordinates for the camera to generated within the scene and a range or distribution of camera orientations (e.g., camera viewpoints) for the camera to point within the scene.

In some instances, the parameter files 802 may indicate object groups and each object group may include a set of parameters that are solely associated with the object group. For example, an object group may be and/or include forklifts, flying objects, or people, and the parameter files 802 may indicate sets of parameters (e.g., size, colors, an asset list from the asset lists 804, and so on) associated with the object groups. Additionally, and/or alternatively, the parameter files 802 may indicate a set of parameters that are specific to capturing stereo images such as a focal length and/or a stereo baseline (e.g., ranges or distributions associated with the focal length and/or the stereo baseline). For instance, the set of parameters may indicate a stereo baseline range that may be slightly biased toward the LEOPARD HAWK stereo camera configuration. The distributions and/or ranges associated with the set of parameters that are specific to capturing stereo images may facilitate in shaping the disparity distribution. Additionally, and/or alternatively, the set of parameters may further indicate bounds (e.g., a focal length upper bound) that are used to reduce poor quality stereo images.

Additionally, and/or alternatively, the set of parameters may be associated with different types of generated scenes and/or stereo images to be included within the synthetic dataset 818. For example, to improve the training of a stereo model (e.g., the Foundational Stereo Model), it may be desired to include synthetic stereo images that are associated with different categories of realism (e.g., realistic style or chaotic style) and/or different use cases (e.g., navigation, driving, and manipulation). As such, the parameter files 802 may include specific sets of parameters for each of the different categories of realism and/or use cases. For example, a set of parameters associated with the chaotic style may indicate parameters that add in randomly posed people character models, furniture, and ground geometries. Additionally, and/or alternatively, the chaotic style may include subsets of styles such as a navigation style, a manipulation style, and a chaos style (e.g., a void style). For the chaos style, the set of parameters associated with the chaos style may indicate parameters that increase the domain randomization levels of object skins, scales, and/or poses. For instance, based on the parameters, a large background object may be added to provide random background texture instead of a background skybox. Additionally, and/or alternatively, for a set of parameters associated with the realistic style, the set of parameters may indicate enabling of physically-realistic layouts by providing rigid bodies to the objects and/or playing the generated scene for a random duration (e.g., 0.25 to 2 seconds). Similar to the chaotic style, the realistic style may include subsets of styles such as navigation, driving, and manipulation (e.g., the use cases described above). For a set of parameters associated with the use case of manipulation within the realistic style, the set of parameters may indicate to provide a group of concave “open container” objects with more expensive collision meshes such that smaller objects may be enabled to fall inside of them (e.g., robotic arms may be used to take or place objects within the open containers). Additionally, and/or alternatively, for a set of parameters associated with the use case of driving within the realistic style, the set of parameters may indicate for the spawn regions of the camera and car to be defined only above roads in the scenario model. Additionally, and/or alternatively, for a set of parameters associated with the use case of navigation within the realistic style (e.g., realistic warehouse scenarios), the set of parameters may indicate for forklift models to be added and tines inside each model to obtain extra diversity with independently random materials and heights. In addition, the forklifts may be oriented such that they are more often oriented horizontally.

An exemplary inheritance tree that shows the parameter sets for each data category (e.g., the different categories of realism and/or use cases) is shown in FIG. 8B. For example, FIG. 8B shows an exemplary inheritance tree 830 that includes parameter sets for each data category that are inherited from parent parameter sets, in accordance with an embodiment. The inheritance tree 830 includes blocks 831-843 (e.g., individual parameter files) that each may include and/or is associated with one or more parameters. In some examples, the inheritance tree may include additional blocks such as additional blocks that are at the same levels as the warehouse block 840, kitchen block 841, attic block 842, and the intersection block 843. For example, the additional blocks at this level may include, but are not limited to, an office block, a robot lab block, and a hospital block.

For instance, to generate synthetic stereo images that are within different realistic styles and/or use cases, scenes may be generated by the replicator composer 812. In order to have the generated synthetic dataset 818 include a number of different realistic styles and/or use cases, each scene that is generated by the replicator composer 812 may be directed to a realistic style and/or a use case. For example, based on manual input and/or an algorithm/process (e.g., a randomized algorithm and/or process), a selection of a particular realistic style and/or use case may be selected. For instance, in a first iteration, a chaotic style scene may be selected. In a second iteration, a particular type of chaotic style scene, such as a void (e.g., chaos) chaotic style scene may be selected. In a third iteration, a manipulation style scene associated with a kitchen may be selected, and so on.

For each iteration, the replicator composer 812 may utilize different parameters that are based on the inheritance tree 830. For example, referring to the inheritance tree 830, in the first iteration, the chaotic style scene may be selected and thus the parameters to be utilized (e.g., loaded and/or retrieved) may include the parameters within the chaotic block 833 (e.g., a chaotic parameter file) as well as the blocks that are above the chaotic block 833 within the inheritance tree 830 such as the stereo depth 832 block and the default settings 831 block. Similarly, in the second iteration (e.g., the void chaotic style scene), in addition to the blocks 831-833, the void block 837 may also be utilized. In the third iteration, the kitchen block 841, the manipulation block 839, the realistic block 834, the stereo depth block 832, and the default settings block 831 may be utilized.

In other words, based on a scene to be generated by the replicator composer 812, an inheritance tree such as the exemplary inheritance tree 830 shown in FIG. 8B may be used to determine a set of parameters that are then used to generate the scene. The set of parameters may include parameters for the lowest block of the inheritance tree as well as the blocks that are above it in the inheritance tree.

In some examples, the default settings block 831 may indicate parameters such as dataset size and dataset format. The stereo depth block 832 may indicate parameters that are associated with stereo images such as a stereo baseline parameter, a focal length parameter, and/or a camera perspectives parameter. The chaotic block 833 may indicate parameters for defining randomized object textures including checkerboard patterns and/or randomized dynamic lighting such as a green sky or bright pink point light source spawned near an object. The realistic block 834 may indicate parameters such as posed people and objects with a randomized from a list of models that are given collision meshes and dropped onto a scene. The chaotic void block 837 may indicate a randomized void color and/or skybox. The chaotic navigation block 835 may indicate a randomly textured floor plane and/or background plane. The realistic warehouse block 840 may indicate randomized forklift models and/or a specific background warehouse model wherein the camera and objects are spawned.

Returning to FIG. 8A, the asset lists 804 may include a list of assets that are to be included within the scenes. For example, the parameter files 802 may indicate an object group such as a flying object group and may indicate one or more asset lists from the asset lists 804 associated with the object group. For instance, the parameter files 802 may indicate a flying object group that identifies a warehouse asset list, an office asset list, and a hospital asset list. Following, each of the asset lists 804 may indicate particular object models. For example, the warehouse asset list may indicate object models such as a traffic cone, wet floor sign, cardboard box, and so on. In some examples, the asset lists 804 may indicate a storage location, link, or identifier to the model file for the particular object (e.g., a link to a Universal Scene Description (USD) file for the particular object).

After obtaining the parameter files 802 and the asset lists 804, parameter parsing 806 may be used to parse through the parameter files 802 and the asset lists 804 to obtain the primitives 808 and the distributions 810. For example, the parameter files 802 may indicate key-value pairs for different parameters, and the different parameters may be associated with static parameters such as numbers, strings, Booleans, and/or tuples. Additionally, and/or alternatively, the different parameters may be associated with randomized parameters such as distributions (e.g., a uniform distribution, a normal distribution, a range distribution, and/or a choice distribution). Based on parsing the parameter files 802 and the asset lists 804, the primitives 808, which may include the static parameters, and the distributions 810, which may include the randomized parameters/distributions, may be obtained.

For instance, the camera coordinates indicated by the parameter files 802 may indicate a uniform distribution such as a distribution from “0” to “10” for each of the x, y, and z coordinates. As such, the distributions 810 may include the uniform distribution of the camera coordinates. Additionally, and/or alternatively, the focal length and the stereo baseline indicated by the parameter files 802 may indicate a range or uniform distribution from “0” to “5”, and the distributions 810 may include the distributions for the focal length and stereo baseline. Additionally, and/or alternatively, the primitives 808 may indicate an object count such as “5”, which may be static (e.g., non-changing for the generation process). In some variations, example primitives 808 and/or distributions 810 may include:
obj_model: Choice (“forklifts.txt”)
camera_coord: Choice ([Uniform ((0, 0, 0), (1, 1 1)), Uniform ((−5,−5,−5), (0, 0, 0))]

In the first example above, this may show randomly selecting a forklift model from a list of model assets defined in a text file. In the second example above, this may show a simplified version of defining spawn regions within a given scenario model associated with the realistic style. For instance, the second example above may indicate randomly selecting a uniform spawn region from a list.

The primitives 808, the distributions 810, and information from a nucleus server 814 and a custom codebase 816 may be provided to the replicator composer 812. The nucleus server 814 may include a server or database that stores sets of virtual assets. For example, the nucleus server 814 may store model files (e.g., USD files) associated with a plurality of virtual assets that may be identified by the asset lists 804 and the parameter files 802. By storing the virtual assets in the nucleus server 814, many different developers may have access and may be able to alter, change, and/or modify the virtual assets. In some examples, the nucleus server 814 may store material files (e.g., files indicating material types of objects), images, texture files, three-dimensional (3D) geometry of different models, and/or other information associated with the virtual assets.

The custom codebase 816 may include code (e.g., custom code) that is used for scene generation. For example, developers may write and run custom or unique code that is executed for particular scenes to be generated to enable increased flexibility in generation. As such, the developers may include code within the custom codebase 816, and the code within the custom codebase 816 may be provided to the replicator composer 812.

The replicator composer 812 may obtain the inputs and use the inputs to generate a synthetic dataset 818. FIG. 8C shows an overview 850 for using a replicator composer 812 to generate the synthetic dataset 818, in accordance with an embodiment.

For instance, the sampling block 852 may perform sampling of the primitives 808 and the distributions 810. For example, the sampling block 852 may sample the distributions associated with the focal length and the stereo baseline to obtain a sample focal length and a sample stereo baseline. The sampling block 852 may perform sampling of other distributions 810 and/or primitives 808 such as sampling to determine objects to generate within the scene. The sampling block 852 may provide the scene samples to the scene generation 854.

The scene generation 854 may generate one or more scenes based on the scene samples from the sampling block 852, nucleus server information from the nucleus server 814, and/or custom code from the custom codebase 816. For example, the scene samples may indicate one or more objects to be generated within the scene. The scene generation 854 may obtain nucleus server information from the nucleus server 814 (e.g., USD files associated with the objects) and use the nucleus server information to generate the objects within the scene. Additionally, and/or alternatively, the scene generation 854 may use one or more methods and/or processes to generate the scene.

For example, in some embodiments, the scene generation 854 may initially use the camera coordinates and/or orientation to generate the camera at a particular position within the scene and direct the camera to a particular viewpoint. In other words, the scene samples may indicate coordinates (e.g., x, y, and z coordinates) indicating a location for the camera to be within the scene and orientation information indicating a camera orientation for the camera. The scene generation 854 may generate a camera at the specified coordinates and the camera orientation. Following, the scene samples may indicate positional information and orientation information associated with one or more objects to be generated within the scene. For instance, for each object to be generated within the scene, the scene samples may indicate an object distance, an object horizontal field of view (FOV) location, and an object vertical FOV location. The scene generation 854 may determine a coordinate point within the scene to generate each of the objects based on the scene samples and the nucleus server information. Additionally, and/or alternatively, the scene samples may indicate a background (e.g., a warehouse background or an outdoor background such as the backgrounds shown in the synthetic images 700 of FIG. 7) and the scene generation 854 may generate a scene with the indicated background.

In some embodiments, based on the scene samples and the nucleus server information, the scene generation 854 may initially generate the objects within the scene and a location of the camera. Subsequently, the scene generation 854 may determine a center of mass of all of the objects (e.g., based on an average of the coordinates of each of the objects that were generated within the scene). Based on the center of mass, the scene generation 854 may determine a camera orientation for the camera and direct the viewpoint of the camera based on the camera orientation. In other words, the scene generation 854 may direct or point the viewpoint of the camera to be at the center of mass of the objects that are generated within the scene.

In some instances, instead of directing the viewpoint of the camera to the center of mass, the scene generation 854 may use an offset (e.g., a random offset that is based on the scene samples) and/or a random camera pose (e.g., a random camera pose that is based on the scene samples). Additionally, and/or alternatively, prior to determining the center of mass, the scene generation 854 may determine object coordinates that are outliers. For example, the scene generation 854 may determine a standard deviation of the object coordinates for the objects to be generated within the scene. Based on the standard deviation and the object coordinates, the scene generation 854 may determine object outliers, and remove the object coordinates associated with the outliers. After removing the object coordinates associated with the outliers, the scene generation 854 may determine the center of mass of the remaining objects of the scene and use the center of mass to determine the viewpoint of the camera.

Additionally, and/or alternatively, in some variations, the scene generation 854 may obtain information indicating spawn regions within the scene. For example, the spawn regions may indicate regions within the scene where the camera is allowed to spawn. Thus, based on the spawn regions and/or the camera information (e.g., the camera coordinates and/or orientation) from the scene samples, the scene generation 854 may generate the camera within the scene. Additionally, and/or alternatively, the scene samples may indicate a background and the scene generation 854 may generate a scene with the indicated background.

After generating the scene, the rejection criteria 856 may be used to modify and/or reject the generated scene. For example, the rejection criteria 856 may include one or more rules, and the rejection criteria 856 may analyze the generated scene based on the one or more rules. Based on the analysis, the rejection criteria 856 may indicate to modify and/or reject the generated scene. For example, based on the generated scene being too bright or too dark (e.g., based on luminance and/or pixel values such as red, green, blue (RGB)), the rejection criteria 856 may determine to reject the scene. Additionally, and/or alternatively, the scene may indicate camera coordinates that generate a camera within the boundaries of a generated object. Based on an indication that the camera is within the boundaries of the generated object, the rejection criteria 856 may modify the scene such as by moving the camera coordinates to new coordinates (e.g., backwards or away from the boundaries of the generated object).

Based on satisfying the one or more rules, the replicator composer 812 may use the data capture 858 to capture data associated with the generated scene. The captured data may be used to generate the synthetic dataset 818. For example, the data capture 858 may be used to capture left and right stereo images of the scene. Additionally, and/or alternatively, based on the generated scene, the data capture 858 may capture a disparity map (e.g., a left disparity map or a disparity map associated with the left camera), an occlusion mask, a segmentation mask, and/or other information associated with the generated scene. As such, the synthetic dataset 818 that is generated from the replicator composer 812 may include one or more data types such as, but not limited to, left and right stereo images, disparity maps, occlusion masks, and/or segmentation masks.

Furthermore, the data capture 858 may also obtain metadata 820 associated with the scene. For example, the metadata 820 may be any type of data that is associated with the scene such as, but not limited to, the focal length and/or stereo baseline that is used from the scene, information from the scene samples that were obtained from the sampling block 852, and/or any other information associated with the generated scene.

Subsequently, the replicator composer 812 may continuously repeat to generate additional data (e.g., stereo images and/or disparity maps) that are included in the synthetic dataset 818 and/or metadata 820. For example, after performing data capture 858 to capture stereo images and disparity maps associated with the generated scene, the sampling block 852 may obtain new scene samples. The scene generation 854 may generate new scenes. The rejection criteria 856 may determine whether to reject and/or modify the scenes. Then, the data capture 858 may capture new data (e.g., new stereo images and/or disparity maps) associated with the new scenes and/or metadata associated with the new scenes.

As such, the synthetic dataset 818 may include data such as a plurality of synthetic stereo images, synthetic disparity maps, and/or other synthetic data. In other words, as described above, embodiments of the present disclosure may generate a large-scale synthetic training dataset (e.g., the synthetic dataset 818). The synthetic dataset 818 may account for crucial stereo matching challenges such as reflections, low-texture surfaces, and severe occlusions. Additionally, and/or alternatively, embodiments of the present disclosure may perform domain randomization to augment dataset diversity. Additionally, and/or alternatively, high-quality 3D assets with abundant textures and path-tracing rendering may be leveraged by embodiments of the present disclosure. FIG. 7 shows a few sample synthetic images 700 from an exemplary synthetic dataset 818 including both structured indoor and outdoor scenarios, as well as more diversely randomized flying objects with various geometries and textures under complex yet realistic lighting.

In some examples, the synthetic dataset 818 (e.g., the generated plurality of synthetic stereo images) may be associated with different categories of realism and/or use cases. For example, the synthetic dataset 818 may include categories of realism such as realistic style synthetic data and chaotic style data. Additionally, and/or alternatively, the synthetic dataset 818 may include three categories of use cases-navigation, driving, and manipulation. For example, based on the parameters from the parameter list 802 that are described above, the chaotic style data may include stereo images associated with chaotic style scenes that may involve large numbers of flying distractors and simple scene layouts that include flying distractors and simple scene layouts that include infinitely far skybox and a back-ground plane. The lighting and object appearances (e.g., texture and material) of the stereo images may be highly randomized. In some examples, the chaotic style data may include particular subsets of data such as chaos style data (e.g., void data associated with the void block 837 from FIG. 8B). The chaos style data may include stereo images associated with chaos scenes that are even more chaotic than other chaotic style scenes. For example, the chaos scenes may include even less realism such as including a plurality of objects floating in a void. In some instances, the chaos scenes might not include furniture, walls, floors, robots, or other similar types of objects. The realistic style data may include stereo images associated with indoor and outdoor scene models where the camera may be restricted and located at predefined areas (e.g., based on the indicated spawn regions within the scene). The object assets that are included within the scene may be dropped and applied with physical properties for collisions.

In some instances, the realistic style data may further include stereo images associated scenes from the three categories of use cases described above. For instance, in the navigation use case, the camera poses may often be in parallel to the ground and objects may often be spawned further away. The objects such as free-standing walls, furniture, and digital humans may be sampled by the sampling block 852 more frequently. In the driving use case, the camera within the scene may often be in parallel to the ground above the ground and the objects are often spawned further away. Objects such as vehicles, digital humans, poles, signs, and speed bumps may be sampled with a higher probability. In the manipulation use case, the camera may be oriented to face front or downward as in ego-centric views and objects may often be spawned in closer range to resemble interaction scenarios. The objects such as household or grocery items, open containers, robotic arms may be sampled with higher probability.

In some examples, the data generation process to generate the synthetic dataset 818 may involve and/or utilize specific hardware and/or software such as utilizing the NVIDIA OMNIVERSE. Additionally, and/or alternatively, the data generation process to generate the synthetic dataset 818 may utilize path-tracing with 32 to 128 samples per pixel for high-fidelity photorealistic rendering. In some examples, the data generation may be performed across 48 NVIDIA A40 graphics processing units (GPUs) for a particular time duration (e.g., ten days). In some instances, more than 5,000 object assets may be collected from varying sources including artist designs and three-dimensional (3D) scanning with high-frequency geometry details. The object assets may be divided into one or more groups such as furniture, open containers, vehicles, robots, floor tape, free-standing walls, stairs, plants, forklifts, dynamically animated digital humans, and/or other obstacles and/or distractors. Each group may be defined with a separate randomization range for sampling locations, scales, and/or appearances. In addition, embodiments of the present disclosure may curate multiple large scene models (e.g., twelve models), multiple skybox images (e.g., sixteen images), multiple materials (e.g., more than 150 materials), and multiple textures (e.g., 400 textures) for tiled wrapping on object geometries for appearance augmentation. These textures may be obtained from real-world photos and/or procedurally generated random patterns.

In some examples, for each data sample, embodiments of the present disclosure may randomly sample the stereo baseline camera focal length to diversify the coverage of FOVs and disparity distributions. Next, objects may be spawned into the scene in two different methods to randomize the scene configuration. The first method may include the camera being spawned in a random pose and the objects are added relative to the camera at random locations. The second method may include objects being spawned near a random location, and the camera being spawned nearby and oriented to the center of mass of the object clutter.

In some variations, light types for the scenes may include global illumination, directed sky rays, lights baked-into 3D scanned assets, and light spheres which add dynamic lighting when spawned near to surfaces. The light colors, intensities, and directions may be randomized by the replicator composer 812. The lighting vibes such as daytime, dusk, and night may be included within the random sampling ranges.

Returning back to FIG. 8A, the selection criteria 822 and/or the pretrained network 824 may be used to curate or modify the generated synthetic dataset 818. For example, the pretrained network 824 may be a pretrained stereo model such as the Foundational Stereo Model that is described above. The selection criteria 822 may include one or more criteria that are used to reject synthetic data (e.g., synthetic stereo images and/or disparity maps) from the synthetic dataset 818. For example, the selection criteria 822 may include one or more thresholds such as a “bad” pixel percentage threshold. For example, using the synthetic stereo images from the synthetic dataset 818 of a scene, the pretrained network 824 may generate a predicted disparity map. Furthermore, the synthetic dataset 818 may include a groundtruth disparity map (e.g., a disparity map that was obtained by the data capture 858 of the scene generated by the scene generation 854). The predicted disparity map from the pretrained network 824 may be compared to the groundtruth disparity map to determine “bad” pixels. For instance, certain pixels within the predicted disparity map may be ambiguous due to reflections and may thus be inaccurately predicted by the pretrained network 824. As such, based on a comparison of a pixel value of a pixel from the groundtruth disparity map with a pixel value of the same pixel within the predicted disparity map, a determination is obtained of whether the pixel is a “bad” pixel (e.g., the pixel value of the predicted disparity map is substantially different from the pixel value of the groundtruth disparity map). For instance, based on a difference of pixel values from the predicted disparity map and the groundtruth disparity map being greater than a threshold, the pixel may be classified into a first category (e.g., classified as a “bad” pixel). Following, a count of the “bad” pixels within the predicted disparity map may be determined. The count of the “bad” pixels may be used to determine whether to reject the synthetic data (e.g., the stereo images that were used by the pretrained network 824 to generate the predicted disparity map). For example, based on the count of “bad” pixels, the percentage of “bad” pixels (e.g., the count divided by the total number of pixels within the disparity map) may be determined. The percentage of “bad” pixels may be compared to a “bad” pixel threshold (e.g., 60%), and based on the comparison, the synthetic data (e.g., the stereo images) may be kept or removed from the synthetic dataset 818.

Additionally, and/or alternatively, the selection criteria 822 may indicate an absolute error threshold. For example, the groundtruth disparity map may be subtracted from the predicted disparity map to obtain an error associated with the predicted disparity map. Based on comparing the error with the absolute error threshold, the synthetic data (e.g., the stereo images) that was used by the pretrained network 824 to generate the predicted disparity map may be kept or removed from the synthetic dataset 818. The “bad” pixel threshold and the absolute error threshold described above are merely exemplary, and the selection criteria 822 may use any criteria, rule, algorithm, process, threshold, and/or method to curate and/or remove synthetic data from the synthetic dataset 818.

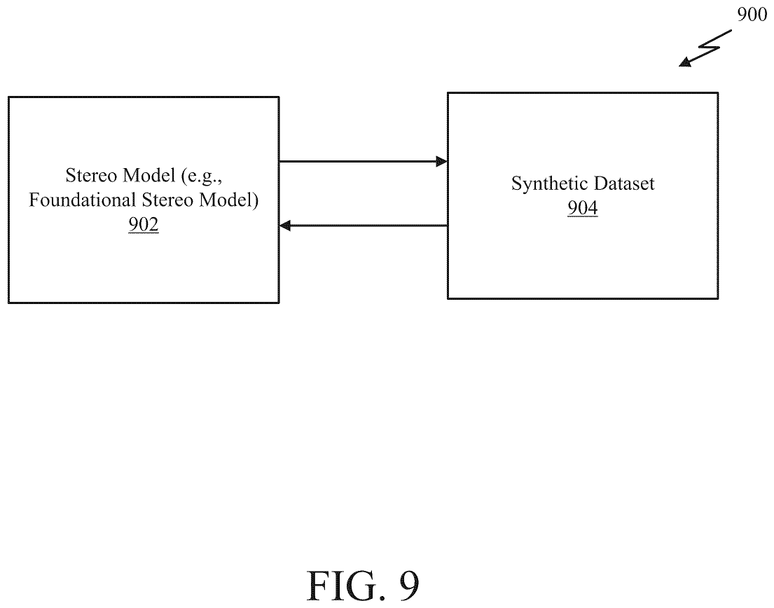

In some embodiments, a self-pruning aspect may be used to generate the synthetic dataset 818 and to train the stereo network (e.g., the Foundational Stereo Model). This is described in FIG. 9. For instance, FIG. 9 shows a process 900 for self-pruning or curating a synthetic dataset using a stereo network, in accordance with an embodiment.

For example, the process 900 may be an iterative process to continuously generate synthetic datasets 904 (e.g., based on using the overview 800 described in FIGS. 8A and 8C) to train the stereo model 902 (e.g., the Foundational Stereo Model), and curate the generated synthetic datasets 904 based on the trained stereo model 902 (e.g., removing synthetic data such as stereo images from the synthetic datasets 904 based on the selection criteria 822). For example, initially, the overview 800 described in FIGS. 8A and 8C may be used to generate a first synthetic dataset 904. Subsequently, the first synthetic dataset 904 may be used to train the stereo model 902, which is described above. After training, the overview 800 may be used to generate a second synthetic dataset 904. Then, instead of using the second synthetic dataset 904 to further train the stereo model 902, the stereo model 902 that was trained using the first synthetic dataset 904 may be used to curate (e.g., remove) synthetic data (e.g., stereo images) from the second synthetic dataset 904. For example, as mentioned above, based on the selection criteria 822, the stereo model 902 may curate and remove stereo images from the second synthetic dataset 904 (e.g., based on a “bad” pixel threshold and/or an absolute error threshold).

Following, the overview 800 may be used to generate a third synthetic dataset 904. The third synthetic dataset 904 may be further used to train the stereo model 902. Subsequently, the overview 800 may be used to generate a fourth synthetic dataset 904. The further trained stereo model 902 (e.g., trained using the third synthetic dataset 904) may be used to curate the fourth synthetic dataset 904. This process may end after the two iterations described above (e.g., the two iterations of training the stereo model 902 and using the trained stereo model 902 to curate a synthetic dataset 904) or one or more additional iterations may be performed. In some examples, after the datasets 904 have been curated by the stereo model 902, the curated datasets 904 may be used to train a second stereo model (e.g., a second Foundational Stereo Model that may be different from the first stereo model 902, which as mentioned above, was used to curate the datasets).

Among other benefits and advantages, embodiments of the present disclosure provide an iterative process 900 that may include generating a synthetic dataset 904 using overview 800, using the synthetic dataset 904 to train a stereo model 902 (e.g., the Foundational Stereo Model), generating a second synthetic dataset 904 using overview 800, and using the trained stereo model 902 to curate the second synthetic dataset 904. In some examples, a third synthetic dataset 904 may be generated using overview 800, and the trained stereo model 902 that is used to curate the second synthetic dataset 904 may be re-trained using the third synthetic dataset 904. In other words, the iterative process 900 may repeat one or more iterations such that one or more synthetic datasets that are generated using overview 800 may be used to train/re-train the stereo model 902, and the stereo model 902 may be used to curate one or more other synthetic datasets that are generated using overview 800. Additionally, and/or alternatively, embodiments of the present disclosure may generate a synthetic dataset 818 that includes categories of realism and use cases. The categories of realism may include realistic style synthetic data and chaotic style data. The categories of use cases may include navigation, driving, and manipulation. Additionally, and/or alternatively, embodiments of the present disclosure may use a scene generation 854 to generate a scene based on determining a center of mass of objects that are generated for a scene and using the center of mass to orient the camera.

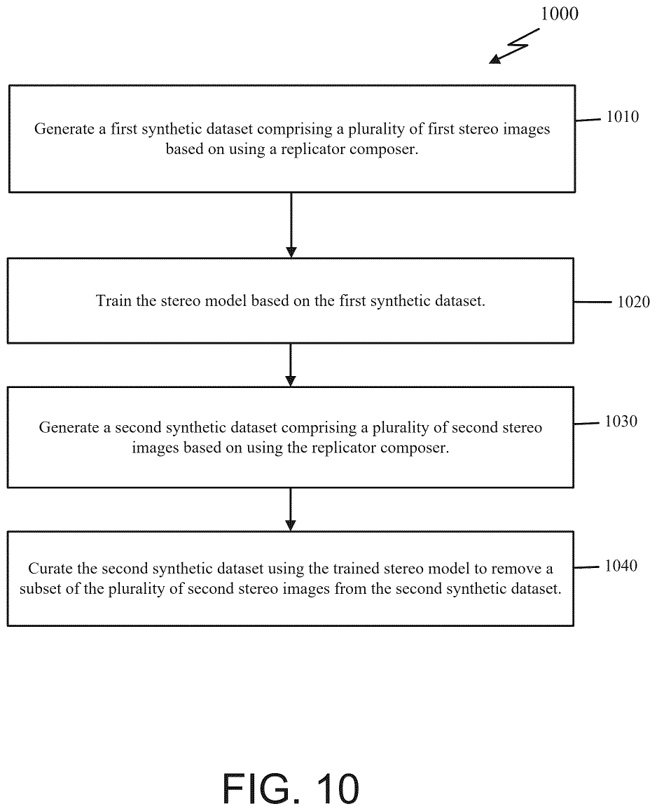

FIG. 10 provides a flow diagram illustrating a method 1000 for curating synthetic datasets using a stereo model, in accordance with an embodiment. Each block of method 1000, described herein, comprises a computing process that may be performed using any combination of hardware, firmware, and/or software. For instance, various functions may be carried out by a processor executing instructions stored in memory. The method 1000 may also be embodied as computer-usable instructions stored on computer storage media. The method 1000 may be provided by a standalone application, a service or hosted service (standalone or in combination with another hosted service), or a plug-in to another product, to name a few. In addition, method 100 is described, by way of example, with respect to the overviews 800 and 850 as well as process 900. However, the method 1000 may additionally or alternatively be executed by any one system, or any combination of systems, including, but not limited to, those described herein. Furthermore, persons of ordinary skill in the art will understand that any system that performs method 1000 is within the scope and spirit of embodiments of the present disclosure.

At step 1010, a first synthetic data comprising a plurality of first stereo images is generated based on using a replicator composer 812.

At step 1020, a stereo model is trained based on the first synthetic dataset.

At step 1030, a second synthetic dataset comprising a plurality of second stereo images is generated based on using the replicator composer 812. In an embodiment, generating the second synthetic dataset comprises: sampling from primitives and/or distributions associated with a parameter file to obtain scene samples, wherein the scene samples indicate object coordinates associated with a plurality of objects to be generated within a scene and a camera coordinate for a camera to be generated within the scene; determining a center of mass associated with the plurality of objects to be generated within the scene; determining a camera viewpoint for the camera based on the determined center of mass; and generating the scene based on the object coordinates, the camera coordinate, and the camera viewpoint.

In an embodiment, determining the camera viewpoint for the camera comprises: obtaining an offset associated with the camera viewpoint; determining an initial camera viewpoint based on the determined center of mass; and modifying the initial camera viewpoint based on the offset to obtain a modified camera viewpoint, and wherein generating the scene is further based on the modified camera viewpoint. In an embodiment, determining the center of mass associated with the plurality of objects to be generated within the scene comprises: determining a standard deviation for the plurality of objects based on the object coordinates associated with the plurality of objects; determining outlier objects from the plurality of objects based on the standard deviation and the object coordinates associated with the plurality of objects; removing the outlier objects from the plurality of objects to obtain a subset of the plurality of objects; and determining the center of mass of the subset of the plurality of objects based on the object coordinates associated with the subset of the plurality of objects.

At step 1040, the second synthetic dataset is curated using the trained stereo model to remove a subset of the plurality of second stereo images from the second synthetic dataset. In an embodiment, curating the second synthetic dataset using the trained stereo model to remove the subset of the plurality of second stereo images from the second synthetic dataset is based on using one or more selection criteria. In an embodiment, the one or more selection criteria indicates a bad pixel threshold and the second synthetic datasets comprises a plurality of groundtruth disparity maps associated with the plurality of second stereo images. Further, curating the second synthetic dataset using the trained stereo model comprises: processing a pair of stereo images from the plurality of second stereo images using the trained stereo model to generate a predicted disparity map; classifying a subset of a plurality of pixels from one of the pair of stereo images into a first category based on comparing the predicted disparity map with a groundtruth disparity map, from the plurality of groundtruth disparity maps, that is associated with the pair of stereo images; and removing the pair of stereo images from the second synthetic dataset based on the bad pixel threshold and the subset of the plurality of pixels that are classified into the first category.

In an embodiment, removing the pair of stereo images from the second synthetic dataset based on the bad pixel threshold and the subset of the plurality of pixels that are classified into the first category comprises: determining a count of the subset of the plurality of pixels that are classified into the first category; determining a count for the plurality of pixels within one of the pair of stereo images; computing a percentage based on the count the subset of the plurality of pixels that are classified into the first category and the count for the plurality of pixels within one of the pair of stereo images; and removing the pair of stereo images from the second synthetic dataset is based on comparing the percentage to the bad pixel threshold.

In an embodiment, the one or more selection criteria indicates an absolute error threshold and the second synthetic datasets comprises a plurality of groundtruth disparity maps associated with the plurality of second stereo images. Further, curating the second synthetic dataset using the trained stereo model comprises: processing a pair of stereo images from the plurality of second stereo images using the trained stereo model to generate a predicted disparity map; computing an absolute error associated with the predicted disparity map based on comparing the predicted disparity map with a groundtruth disparity map, from the plurality of groundtruth disparity maps, that is associated with the pair of stereo images; and removing the pair of stereo images from the second synthetic dataset based on the absolute error threshold and the absolute error associated with the predicted disparity map.

In an embodiment, generating the first synthetic dataset and the second synthetic dataset are based on using a parameter file comprising one or more sets of parameters, and the one or more sets of parameters comprise a focal length parameter and a stereo baseline parameter. In an embodiment, generating the first synthetic dataset and the second synthetic dataset are based on using a parameter file comprising a plurality of sets of parameters, the plurality of sets of parameters comprise chaos style parameters, and the plurality of first stereo images and the plurality of second stereo images comprise stereo images associated with chaos style scenes that are generated based on the chaos style parameters.

In an embodiment, generating the first synthetic dataset and the second synthetic dataset are based on using a parameter file comprising a plurality of sets of parameters, the plurality of sets of parameters indicate chaotic style parameters, and the plurality of first stereo images and the plurality of second stereo images comprise stereo images associated with chaotic style scenes that are generated based on the chaotic style parameters.

In an embodiment, generating the first synthetic dataset and the second synthetic dataset are based on using a parameter file comprising a plurality of sets of parameters, the plurality of sets of parameters indicate realistic style parameters, and the plurality of first stereo images and the plurality of second stereo images comprise stereo images associated with realistic style scenes that are generated based on the realistic style parameters.

In an embodiment, at least one of steps 1010-1040 and/or the further steps described above for method 1000 are performed on a server or in a data center to generate synthetic datasets, and the synthetic datasets are provided to a user device. In an embodiment, at least one of steps 1010-1040 and/or the further steps described above for method 1000 is performed within a cloud computing environment. In an embodiment, at least one of steps 1010-1040 and/or the further steps described above for method 1000 is performed for training, testing, or certifying a neural network employed in a machine, robot, or autonomous vehicle. In an embodiment, at least one of steps 1010-1040 and/or the further steps described above for method 1000 is performed on a virtual machine comprising a portion of a graphics processing unit.

In some examples, embodiments of the present disclosure describe a process for generating a large-scale synthetic training dataset for stereo models. The synthetic training dataset generated by embodiments of the present disclosure may account for crucial stereo matching challenges such as reflections, low-texture surfaces, and/or severe occlusions. Additionally, and/or alternatively, embodiments of the present disclosure may perform domain randomization to augment dataset diversity, including parameters such as, but not limited to, random stereo baseline, focal length, camera perspectives, lighting conditions, and/or object configurations. Furthermore, high-quality 3D assets with abundant textures and path-tracing rendering may be leveraged by embodiments of the present disclosure to enhance realism in rendering and layouts. Additionally, and/or alternatively, embodiments of the present disclosure may be configured to perform an automatic iterative self-curation process that generates synthetic datasets for training stereo models (e.g., the Foundational Stereo Model described above) and utilize the trained stereo models to curate newly generated synthetic datasets.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for curating synthetic datasets using a stereo model, comprising:
generating a first synthetic dataset comprising a plurality of first stereo images based on using a replicator composer;
training the stereo model based on the first synthetic dataset;
generating a second synthetic dataset comprising a plurality of second stereo images based on using the replicator composer; and
curating the second synthetic dataset using the trained stereo model to remove a subset of the plurality of second stereo images from the second synthetic dataset.

2. The computer-implemented method of claim 1, wherein curating the second synthetic dataset using the trained stereo model to remove the subset of the plurality of second stereo images from the second synthetic dataset is based on using one or more selection criteria.

3. The computer-implemented method of claim 2, wherein the one or more selection criteria indicates a bad pixel threshold, wherein the second synthetic datasets comprises a plurality of groundtruth disparity maps associated with the plurality of second stereo images, and wherein curating the second synthetic dataset using the trained stereo model comprises:
processing a pair of stereo images from the plurality of second stereo images using the trained stereo model to generate a predicted disparity map;
classifying a subset of a plurality of pixels from one of the pair of stereo images into a first category based on comparing the predicted disparity map with a groundtruth disparity map, from the plurality of groundtruth disparity maps, that is associated with the pair of stereo images; and
removing the pair of stereo images from the second synthetic dataset based on the bad pixel threshold and the subset of the plurality of pixels that are classified into the first category.

4. The computer-implemented method of claim 3, wherein removing the pair of stereo images from the second synthetic dataset based on the bad pixel threshold and the subset of the plurality of pixels that are classified into the first category comprises:
determining a count of the subset of the plurality of pixels that are classified into the first category;
determining a count for the plurality of pixels within one of the pair of stereo images;
computing a percentage based on the count the subset of the plurality of pixels that are classified into the first category and the count for the plurality of pixels within one of the pair of stereo images; and
removing the pair of stereo images from the second synthetic dataset is based on comparing the percentage to the bad pixel threshold.

5. The computer-implemented method of claim 2, wherein the one or more selection criteria indicates an absolute error threshold, wherein the second synthetic datasets comprises a plurality of groundtruth disparity maps associated with the plurality of second stereo images, and wherein curating the second synthetic dataset using the trained stereo model comprises:
processing a pair of stereo images from the plurality of second stereo images using the trained stereo model to generate a predicted disparity map;
computing an absolute error associated with the predicted disparity map based on comparing the predicted disparity map with a groundtruth disparity map, from the plurality of groundtruth disparity maps, that is associated with the pair of stereo images; and
removing the pair of stereo images from the second synthetic dataset based on the absolute error threshold and the absolute error associated with the predicted disparity map.

6. The computer-implemented method of claim 1, wherein generating the second synthetic dataset comprises:
sampling from primitives and/or distributions associated with a parameter file to obtain scene samples, wherein the scene samples indicate object coordinates associated with a plurality of objects to be generated within a scene and a camera coordinate for a camera to be generated within the scene;
determining a center of mass associated with the plurality of objects to be generated within the scene;
determining a camera viewpoint for the camera based on the determined center of mass; and
generating the scene based on the object coordinates, the camera coordinate, and the camera viewpoint.

7. The computer-implemented method of claim 6, wherein determining the camera viewpoint for the camera comprises:
obtaining an offset associated with the camera viewpoint;
determining an initial camera viewpoint based on the determined center of mass; and
modifying the initial camera viewpoint based on the offset to obtain a modified camera viewpoint, and wherein generating the scene is further based on the modified camera viewpoint.

8. The computer-implemented method of claim 6, wherein determining the center of mass associated with the plurality of objects to be generated within the scene comprises:
determining a standard deviation for the plurality of objects based on the object coordinates associated with the plurality of objects;
determining outlier objects from the plurality of objects based on the standard deviation and the object coordinates associated with the plurality of objects;
removing the outlier objects from the plurality of objects to obtain a subset of the plurality of objects; and
determining the center of mass of the subset of the plurality of objects based on the object coordinates associated with the subset of the plurality of objects.

9. The computer-implemented method of claim 1, wherein generating the first synthetic dataset and the second synthetic dataset are based on using a parameter file comprising one or more sets of parameters, and wherein the one or more sets of parameters comprise a focal length parameter and a stereo baseline parameter.

10. The computer-implemented method of claim 1, wherein generating the first synthetic dataset and the second synthetic dataset are based on using a parameter file comprising a plurality of sets of parameters, wherein the plurality of sets of parameters comprise chaos style parameters, and wherein the plurality of first stereo images and the plurality of second stereo images comprise stereo images associated with chaos style scenes that are generated based on the chaos style parameters.

11. The computer-implemented method of claim 1, wherein generating the first synthetic dataset and the second synthetic dataset are based on using a parameter file comprising a plurality of sets of parameters, wherein the plurality of sets of parameters indicate chaotic style parameters, and wherein the plurality of first stereo images and the plurality of second stereo images comprise stereo images associated with chaotic style scenes that are generated based on the chaotic style parameters.

12. The computer-implemented method of claim 1, wherein generating the first synthetic dataset and the second synthetic dataset are based on using a parameter file comprising a plurality of sets of parameters, wherein the plurality of sets of parameters indicate realistic style parameters, and wherein the plurality of first stereo images and the plurality of second stereo images comprise stereo images associated with realistic style scenes that are generated based on the realistic style parameters.

13. The computer-implemented method of claim 12, wherein the realistic style scenes associated with the stereo images comprise one or more navigation scenes, one or more driving scenes, and/or one or more manipulation scenes.

14. The computer-implemented method of claim 1, wherein at least one of the steps of generating, training, and curating are performed on a server or in a data center to generate the first and second synthetic datasets, and the first and second synthetic datasets are provided to a user device.

15. The computer-implemented method of claim 1, wherein at least one of the steps of generating, training, and curating are performed within a cloud computing environment.

16. The computer-implemented method of claim 1, wherein at least one of the steps of generating, training, and curating are performed for training, testing, or certifying a neural network employed in a machine, robot, or autonomous vehicle.

17. The computer-implemented method of claim 1, wherein at least one of the steps of generating, training, and curating are performed on a virtual machine comprising a portion of a graphics processing unit.

18. A system for curating synthetic datasets using a stereo model, comprising:
one or more processors; and
a non-transitory computer-readable medium having processor-executable instructions stored thereon, wherein the processor-executable instructions, when executed by the one or more processors, facilitate:
generating a first synthetic dataset comprising a plurality of first stereo images based on using a replicator composer;
training the stereo model based on the first synthetic dataset;
generating a second synthetic dataset comprising a plurality of second stereo images based on using the replicator composer; and
curating the second synthetic dataset using the trained stereo model to remove a subset of the plurality of second stereo images from the second synthetic dataset.

19. The system of claim 18, wherein curating the second synthetic dataset using the trained stereo model to remove the subset of the plurality of second stereo images from the second synthetic dataset is based on using one or more selection criteria.

20. A non-transitory computer-readable medium having processor-executable instructions stored thereon for curating synthetic datasets using a stereo model, wherein the processor-executable instructions, when executed, facilitate:
generating a first synthetic dataset comprising a plurality of first stereo images based on using a replicator composer;
training the stereo model based on the first synthetic dataset;
generating a second synthetic dataset comprising a plurality of second stereo images based on using the replicator composer, and
curating the second synthetic dataset using the trained stereo model to remove a subset of the plurality of second stereo images from the second synthetic dataset.

21. The non-transitory computer-readable medium of claim 20, wherein curating the second synthetic dataset using the trained stereo model to remove the subset of the plurality of second stereo images from the second synthetic dataset is based on using one or more selection criteria.
